(19) United States
(12) Patent Application Publication
(10) Pub. No.: US 2002/0062218 A1
(43) Pub. Date: May 23, 2002

(54) Method and system for providing property management services in an on-line computing evironment

(76) Inventor: Carolyn Pianin, Weston, CT (US)

Correspondence Address: KING & SPALDING, 191 PEACHTREE STREET, N.E., ATLANTA, GA, 30303-1763, US

(21) Appl. No.: 09/766,726

(22) Filed: Jan. 22, 2001

Related U.S. Application Data
(60) Provisional application No. 60/252,015, filed on Nov. 20, 2000.

(51) Int. Cl. G06F 17/60

(52) U.S. Cl. 705/1; 705/37

(57) ABSTRACT

Managing commercial real estate property by providing access to multiple commercial real estate services using an on-line property management environment. The on-line property management environment comprises a distributed computer network, such as the global Internet, coupled to numerous clients, a property services server platform connected to a local database, and numerous property information databases. The on-line property management environment improves the efficiency and effectiveness of commercial real estate transactions by providing a Web site that can serve as a commercial real estate professional's workspace to obtain industry specific content, use support tools, benchmark performance, and access vendors in a personalized environment. The Web site can facilitate the offering of multiple services relating to the property management including site appraisal, engineering, and environmental services in an on-line computing environment such as the global Internet.

### FIELD OF THE INVENTION

The present invention is generally directed to property management services and more particularly to selecting, contracting and obtaining property management services including site appraisals, engineering, and environmental services in an on-line computing environment such as the global Internet.

### BACKGROUND OF THE INVENTION

Commercial real estate services represents an extremely valuable market which generates approximately 50.8 billion dollars in annual revenues. The commercial real estate services industry is composed of multiple intermediaries including construction companies, brokers, and appraisers. There are five main classes of rental commercial real estate: office, industrial, retail, hotel, and multi-family. The total market value exceeds 15 trillion worldwide and grows 3% to 5% per year. The commercial real estate industry consists of six core activities: construction, financing, buying and selling, leasing, managing property operations, and procuring the basic products and services such as light bulbs and cleaning services required to run a building. Owners, lenders, and tenants are the principals in the commercial real estate industry.

The four general types of real estate owners include: corporations, entrepreneurs, governments, and institutions. Corporations occupy 41% of the commercial real estate market; whereas, entrepreneurs own approximately 20% of commercial real estate properties. Governments own approximately 20% and institutions own the remaining 19%. The largest corporate owners are generally not in the commercial real estate industry and own and occupy potential rental space. Similarly, government agencies also own and occupy potential rental space. Institutions acting as fiduciaries invest in commercial real estate as part of their asset allocation strategy. Finally, individual entrepreneurs are using their personal equity to own commercial real estate directly. The commercial real estate services industry caters primarily to the larger corporations and institutions leaving the individual entrepreneurs at a disadvantage.

There are numerous tenants in the commercial real estate industry, and they can be grouped into three types: individuals, corporations, and governments. Individuals differ significantly from corporations and governments in terms of property type. Individuals rent property such as multi-family dwellings, self storage facilities, and hotels. Corporations and governments rent retail, office, and industrial space.

Revenues generated from commercial real estate services approximate 50.8 billion dollars annually. The many intermediaries can be grouped by the part of the commercial real estate value chain may serve. As noted above, the commercial real estate value chain is composed of six core activities: construction, financing, buying and selling, leasing, managing, and procuring. Contractors are the most important intermediary for the construction phase of the value chain. Brokers predominate the buy/sell, lease, and finance activities. Property managers work in the management and procurement phase. Presently, individual brokers tend to specialize in leasing, buying/selling, or financing.

A significant problem in the commercial real estate services industry is the long cycle times and high direct and indirect transaction costs in each aspect of the industry. For example, while hiring a property manager typically takes less than a month, other transactions take anywhere from three months for a single financing round to twelve months to sell a building. Further, transaction costs are high because the processes are people intensive and involve multiple parties with linear information flow. Additionally, participants work on many more deals than they actually close. Indirect costs can also be material. Access to market information and new deals can be restricted by brokers to a limited few. For example, a buyer may not receive an opportunity to bid on a building because the broker may have a conflict of interest or an owner may not have access to the best capital source.

Because of the long cycle times and high direct and indirect transaction costs in the commercial real estate industry, there exists a strong need for methods to improve the effectiveness and efficiency of commercial real estate professionals in executing their leasing, financing and buy/sell deals. Furthermore, there is a need to provide low cost access from one participant in the commercial real estate industry to another. There are also needs methods of conducting commercial real estate-related transactions using an Application Service Provider and comprehensive methods of managing commercial real estate property by providing access commercial real estate services using a distributed computer network environment.

That the invention improves over prior methods for managing commercial real estate property and accomplishes the advantages and goals described above will become apparent from the following detailed description of the exemplary embodiments and the appended drawings and claims.

### SUMMARY OF THE INVENTION

The present invention provides a novel method of improving the efficiency and effectiveness of commercial real estate transactions by providing a Web site that can serve as a commercial real estate professional's workspace to obtain industry specific content, use support tools, benchmark performance, and access vendors in a personalized environment. The present invention can provide access to commercial real estate leasing, financing, and buy/sell opportunities, enable users to track and complete their commercial real estate-related deals and allow users to monitor and maintain their commercial real estate portfolios in a more efficient and effective manner than currently available.

The present invention is directed to selecting, contracting and obtaining property management services including site appraisal, engineering, and environmental services in an online computing environment such as the global Internet. The user can use a browser operating on a client coupled to a distributed computing environment, such as the Internet, to access a feature of a property management program module, which is preferably maintained at a remote server as part of an Application Service Provider (ASP) model.

The remote server can also support a portal operation by providing a central Web site for consumer's real estate related operations. For example, as a portal model, a remote server can offer conventional web-based services targeted to real estate consumers by aggregating a variety of real estate related tools and services at a single Web site. The portal can offer consumers the opportunity to conveniently complete due diligence activities for a real estate transaction, analyze market aspects of the transaction, finance the transaction, and access service providers to support the transaction. Advantageously, the portal operated by this server platform can also enable the user to create a “personalizable” workspace for her real estate-related transaction. The portal can further provide a central location in a distributed computing environment for reviewing a consumer's real estate activities, collecting current real estate news research and relevant property and stock market information. In view of the foregoing, it will be understood that the remote server can support both an ASP model and a portal Web site for servicing the needs of real estate consumers.

The Web site can facilitate the offering of multiple services relating to the property management. In one aspect, the Web site hosts a Services section enabling users to obtain soft and firm quotes for appraisal, engineering, environmental, and accounting services. Appraisal services are necessary to obtain reliable valuations of properties of interest. In another aspect, the Web site offers a property valuation service. Similarly, engineering services are provided by the Web site. Preferred engineering services includes a property condition report. A property condition report can provide the user with information relating to structural integrity of buildings and the like or estimates of build-out costs or costs of refitting the structure for specific commercial needs. The Web site also provides environmental services, preferably services relating to risk assessments concerning contamination on or in commercial real estate. The Web site can offer different levels of risk assessments. A preferred risk assessment and report is a Phase I Federal National Mortgage Association (FNMA)/Federal Home Loan Mortgage Corporation (FHLMC) Protocol Environmental Assessment Report. Lastly, the Web site provides accounting services including but not limited to payroll services, employee benefits services, tax services, banking services and the like.

### BRIEF DESCRIPTION OF THE DRAWINGS

FIG. 1 is a block diagram of a representative operating environment for an exemplary embodiment of the present invention.

FIG. 2 is a block diagram of the primary components of a real estate services server platform for an exemplary embodiment of the present invention.

FIGS. 3A-3E collectively described as FIG. 3 are process diagrams illustrating steps for providing due diligence-related services including appraisal, engineering and environmental services for the property management field in an on-line environment in accordance with an exemplary embodiment of the present invention. FIG. 3 also provides process diagrams illustrating steps for providing services under the categories Help You Save Money, Run Your Business More Efficiently, and a Quick Feature Overview.

FIG. 4 is a representative display screen for a Web site supporting a delivery of due diligence-related services including appraisal, engineering, and environmental services in the property management field in accordance with an exemplary embodiment of the present invention.

FIGS. 5A-5E collectively described as FIG. 5 are representative Web site display screens for selecting an appraisal service that offers a property evaluation report for the property management field in accordance with an exemplary embodiment of the present invention.

FIGS. 6A-6E collectively described as FIG. 6 are representative Web site display screens for selecting an engineering service that offers a property evaluation report for the property management field in accordance with an exemplary embodiment of the present invention.

FIG. 7A-7E collectively described as FIG. 7 are representative Web site display screens for selecting an environmental service that offers a property evaluation report for the property management field in accordance with an exemplary embodiment of the present invention.

### DETAILED DESCRIPTION OF THE EXEMPLARY EMBODIMENTS

The present invention is directed to selecting, contracting and obtaining property management services including site appraisal, engineering, and environmental services in an on-line computing environment such as the global Internet. The user can use a browser coupled to the Internet to access a feature of a property management program module which is preferably maintained at a remote server as part of an Application Service Provider (ASP) model.

The remote server can also support a portal operation by providing a central Web site for consumer's real estate related operations. For example, as a portal model, a remote server can offer conventional web-based services targeted to real estate consumers by aggregating a variety of real estate related tools and services at a single Web site. The portal can offer consumers the opportunity to conveniently complete due diligence activities for a real estate transaction, analyze market aspects of the transaction, finance the transaction, and access service providers to support the transaction. Advantageously, the portal operated by this server platform can also enable the user to create a “personalizable” workspace for her real estate-related transaction. The portal can further provide a central location in a distributed computing environment for reviewing a consumer's real estate activities, collecting current real estate news research and relevant property and stock market information. In view of the foregoing, it will be understood that the remote server can support both an ASP model and a portal Web site for servicing the needs of real estate consumers.

On-Line Real Estate Services Environment

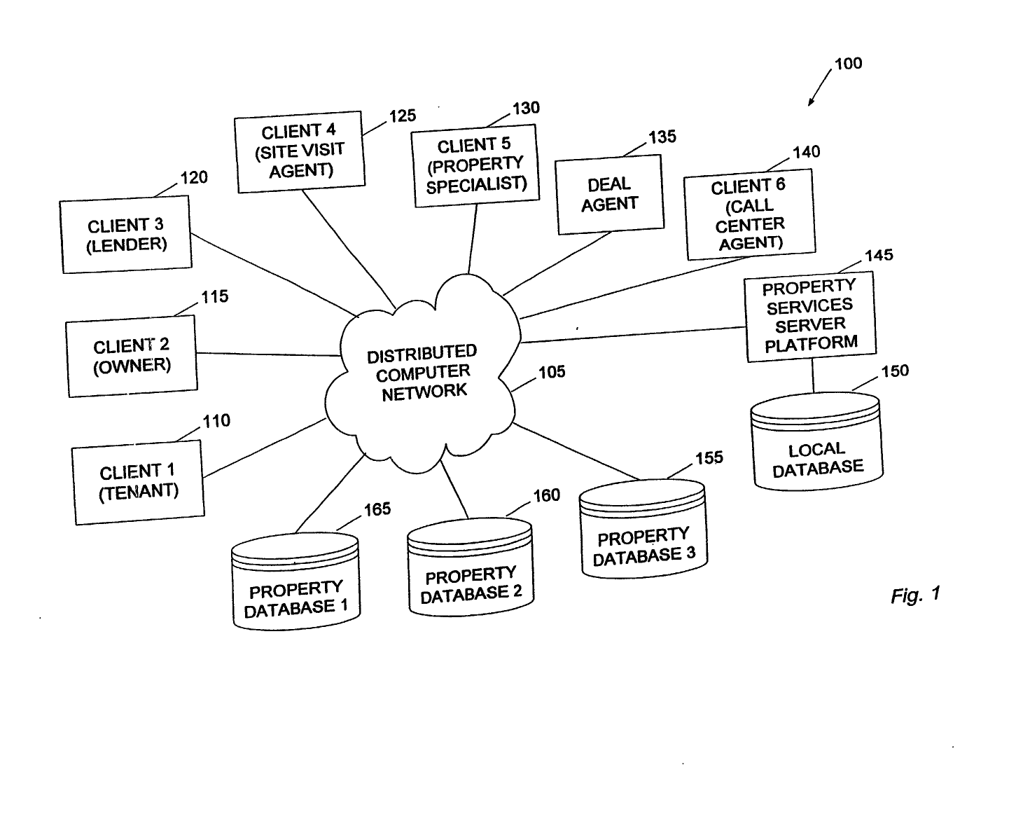

Turning now to the figures, in which like reference numbers are assigned to like elements, FIG. 1 is a block diagram illustrating the primary components of a representative operating environment for an exemplary embodiment of the present invention. An on-line property management environment 100 comprises a distributed computer network 105, such as the global Internet, coupled to numerous clients 110-140, a property services server platform 145 connected to a local database 150, and numerous property information databases 155-165. For the client server computing environment shown in FIG. 1, the client computers 110-115 represent typical users of property services hosted by the property services server platform 145. The client computers 120-140 represent service providers for servicing the activities of users in the property management field. For example, typical consumers of the property services accessible at the property server platform 145 by the distributor computer network 105 include property tenants and property owners, as shown at the client computers 110 and 115. Representative service providers in the property management field include lenders, site visit agents, engineers, appraisal and environmental specialists, field agents, and call center agents, as shown in connection with client computers 120-140.

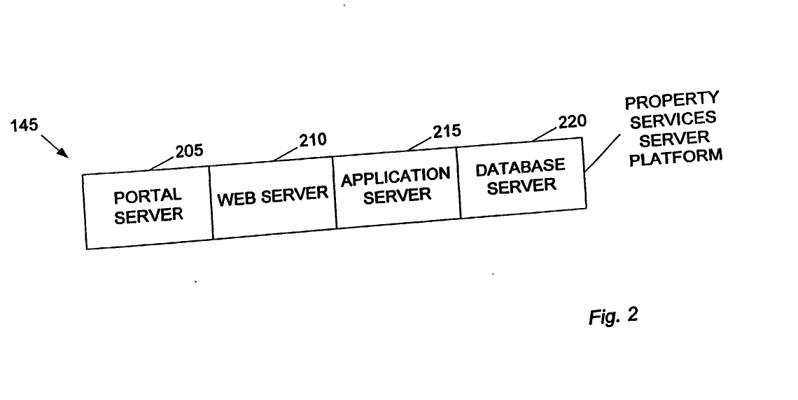

FIG. 2 is a block diagram illustrating the primary components of a real estate services server platform for an exemplary embodiment of the present invention. The property services server platform can contain: a portal server 205, a web server 210, an application server 215, and a database server 220. More specifically, a property services server platform 145 can provide real estate industry services, including content, decision support tools, transaction exchanges, and access to key members of the real estate community and its service providers. For example, the property services server platform 145 can provide users operating client computers with convenient access to budgeting, forecasting, evaluation tools in the real estate field. The property services server platform 145 also enables the user, such as a tenant at the client 110 or property owner at the client 115, to communicate by electronic mail with a lender at the client 120; a site visit agent at the client 125; a property specialist operating at the client 130; a deal agent operating at the client 135; or a call center agent operating at the client 140. The property services server platform 145 also can publish information at one or more Web site pages to facilitate the matching of a user such as a tenant or owner to a lender, site visit agent, service provider or deal agent. Although the matching of a user to a desired party can be facilitated by the on-line environment shown in FIG. 1, it will be appreciated that communications between these parties can be further accomplished by a variety of conventional means, including telephone, electronic mail messages, facsimile correspondence, mail delivery, etc.

The electronic communications framework of the on-line operating environment 100 enables the user, such as a tenant or owner, to effectively identify and communicate with a variety of parties associated with the typical evaluation and closing of a real estate transaction. A lender, represented by the client 120, can work with a property owner or tenant to support financing requirements in connection with a real estate transaction. A site visit agent, represented by the client 125, can support a tenants onsite review and analysis of a property under consideration a property. A property specialist, represented by the client 130 can provide property related expertise, such as engineering, appraisal, or environmental services, to a user in connection with a real estate transaction. A deal agent, represented by the client 135, can assist a user by screening, negotiating, and closing real estate related transactions on behalf of that user.

Site Visit Agent

A site visit agent 125, typically based in a location proximate to the property or space of interest, can support a purchase or lease decision by showing the property or space to the parties of a transaction, such as tenants, owners, and lenders. For example, a site visit agent 125 can visit a building or space of interest with an owner or purchaser and offer her expertise about the visit site, including configuration alternatives, build-out costs, etc. In contrast to a real estate broker, who often juggles several real estate transaction tasks at once, a site visit agent is focused solely on showing properties on behalf of her customer. A user can select a site visit agent 125 from information published at the property services server platform 145 or by requesting information from a call center agent 140. The user communicates with a select site visit agent, represented by the client 125, by the on-line environment 100 or by other conventional means.

Property Specialist

Property services server platform 145 also provides a convenient on-line forum for connecting a variety of property specialists to the potential users of those services. For example, a tenant operating a client 110 can obtain information from the property services server platform 145 about the services offered by property specialists represented by the client 130, including appraisal, engineering, and environmental services. This information can include: the identity of property specialists within a specified profession such as engineering, appraisal, or environmental sciences; contact information for property specialists in the selected field; and fee estimates for services provided by the listed property specialists. Consequently, the real property services server platform 145 provides a marketplace that enables a user to identify and to select a desired service provider within the framework of the on-line environment 100.

For example, a customer operating from a client site, such as a tenant client 110 or an owner client 115, can gain access to a service provider based upon the user's issuance of a request to the property services server platform 145. In turn, the property services server platform 145 can respond to this request by presenting information sufficient to facilitate a communication between the parties. For example, this communication link can be established by the server platform 145 by a hyperlink to a service provider's Web site, electronic mail to a service provider, or publication of service provider contact information.

Deal Agent

A deal agent, represented by the client 135, can work on behalf of the user to support the completion of property related transactions, including leasing, financing, and buy/sell exchanges. The property services server platform 145 provides an on-line forum listing deal agents available to support a user's real estate transaction. In the absence of a relationship with another service provider, the user can rely upon the real estate expertise of a deal agent in evaluating and completing a property transaction. A user operating the client site, such as client 110 or 115, can obtain the services of a deal agent by issuing a request to the property services server platform 145 or by contacting a customer service agent at the client 140. For example, the property services server platform 145 can establish communications between the user and a deal agent by selection of a hyperlink to a deal agent's Web site, electronic mail to a deal agent, or publication of contact information for a deal agent. The user can also contact a customer service agent based upon contact information published at the property services server platform 145.

Services Supported by Web Site

Turning now from service providers to the specific services supported by the invention, the property services server platform 145 can host a Web site containing a Services section in support of the services offered by property specialists. The Web site can facilitate the offering of multiple services relating to the property management. In one exemplary embodiment, the Web site hosts a Services section enabling users to obtain soft and firm quotes for appraisal, engineering, environmental, and accounting services. Appraisal services are necessary to obtain reliable valuations of properties of interest. In a preferred embodiment, the Web site offers a property valuation service. Similarly, engineering services are provided by the Web site. Preferred engineering services includes a property condition report. A property condition report can provide the user with information relating to structural integrity of buildings and the like or estimates of build-out costs or costs of refitting the structure for specific commercial needs. The Web site also provides environmental services, preferably services relating to risk assessments concerning contamination on or in commercial real estate. The Web site can offer different levels of risk assessments. A preferred risk assessment and report is a Phase I Federal National Mortgage Association (FNMA)/Federal Home Loan Mortgage Corporation (FHLMC) Protocol Environmental Assessment Report. Lastly, the Web site provides accounting services including but not limited to payroll services, employee benefits services, tax services, banking services and the like.

A user of the Web site can also request additional information from participating service providers. A user can select a link and be connected to a service provider's information page or to a service provider's Web page. In one embodiment, a user has a choice of selecting links to recruiters for real estate employees, financial services to help run her business, or providers of equipment or supplies of interest. Preferred accounting services include general ledger accounting, bookkeeping services, and automated accounting services.

In another embodiment, commercial real estate brokers and property sellers use the Services section to obtain soft or firm quotes from potential appraisal, engineering, or environmental service providers. Brokers can obtain quotes from service providers for their clientele. Similarly, buyers can use the Services section to obtain soft or firm quotes directly from potential appraisal, engineering, or environmental service providers. Because the large number of potential users of the Web site, dealmakers, entrepreneurs, or owners can use the Services section to obtain quotes and can leverage the Web site's large volume buying power to obtain discounts on business-related products and services. Lenders can use the Services section to obtain quotes from potential service providers for the lender's clientele during the loan process. Office Administrators of businesses involved in commercial real estate can use the Web site to leverage the buying power of the on-line marketplace to obtain discounts on business-related products and services. For example, an Office Administrator can be an individual working in a commercial real estate broker's office. The Office Administrator can use the Web site of the present invention to obtain quotes on services and products. Sellers of commercial real estate can use the Service section to obtain soft or firm quotes from potential providers of accounting, appraisal, engineering, and environmental services. Potential service providers can use the Services section to provide quotes to Web site users and identify qualified business opportunities.

Users of the Web site can be grouped into different categories and given different levels of access to different areas of the Web site. Access to services supported by the Services section can be restricted to those users who subscribe to specific services. In one exemplary embodiment, user groups can consist of Guest, Registered User, Subscriber, Company Account Holder, and Real Estate User. Guests are able to access basic services and functions only. A Registered User can access basic services as well as access all Registered Services. Registered Services include obtaining quotes for services from participating vendors or other services offered at a premium price. A Subscriber can access basic services and functions as well as additional services based on subscription level. A Company Account Holder can access basic services and functions as well as additional services based on a company package and its negotiated terms. Real Estate Users can access basic services and functions, additional services provided with the company subscriber package, and specific research areas and functions. Vendors can access Vendor Maintenance areas and functions as well as basic services and functions except those of competing vendors. A Vendor can have a Web site Administrator who can have access to Guest and Registered services and functions, Web site specific areas and functions, Vendor-specific areas and functions, and Module Administration and content management functions. A Web site Administrator is an individual responsible for monitoring and maintaining a Vendor's participation and activities on the Web site. For example, a Web site Administrator can set up specific hypertext links and information on the Web site for the Vendor. These links and information can be on particular services and products provided by the Vendor. The Vendor can also have a Module Administrator who can have access to Guest and Registered services and functions and Service Module Administration functions. A Module Administrator is an individual that monitors and maintains access to the Vendor and Vendor information on the Web site. The Module Administrator can be responsible for a Company Account Administrator who has access to Guest and Registered services and functions. A company Account Administrator is an individual responsible for monitoring and maintaining a user's account on the Web site including facilitating the purchase of products and services provided by the Vendor.

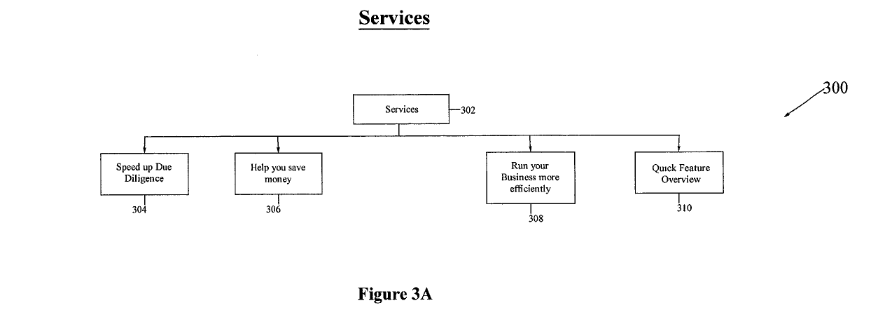

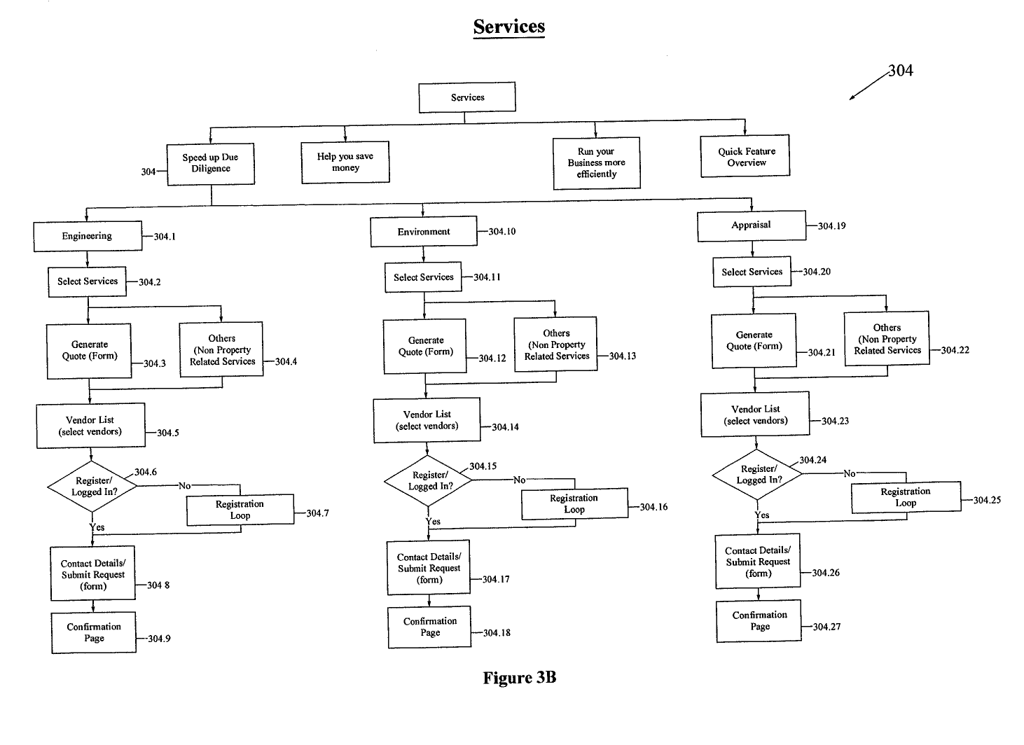

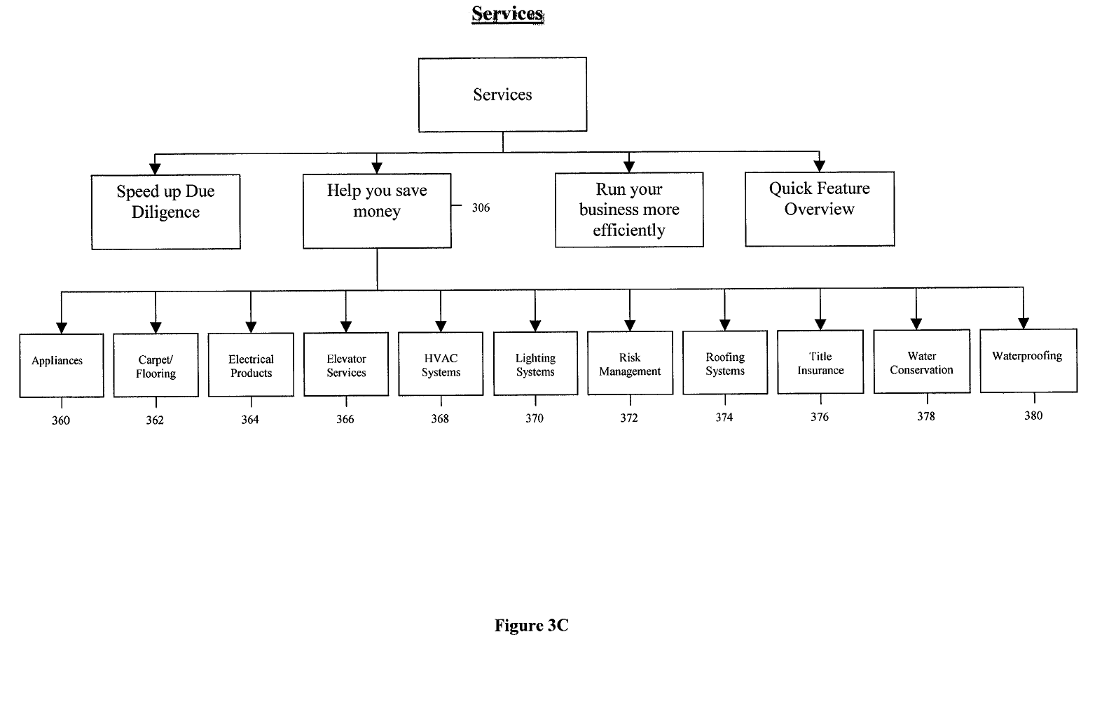

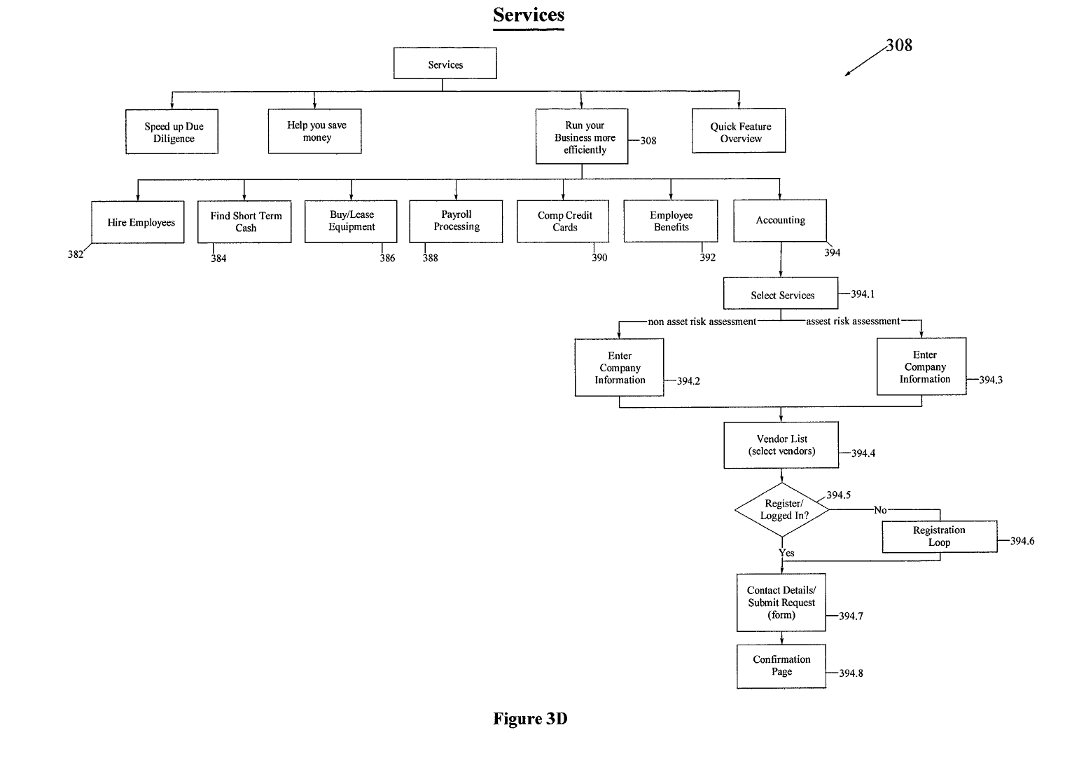

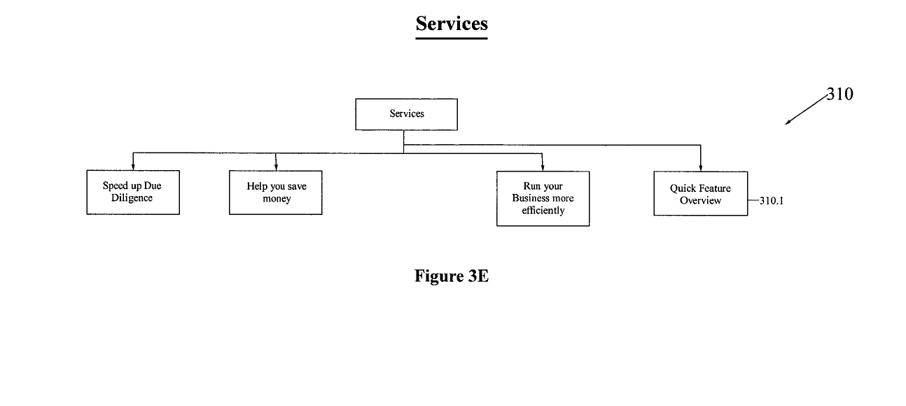

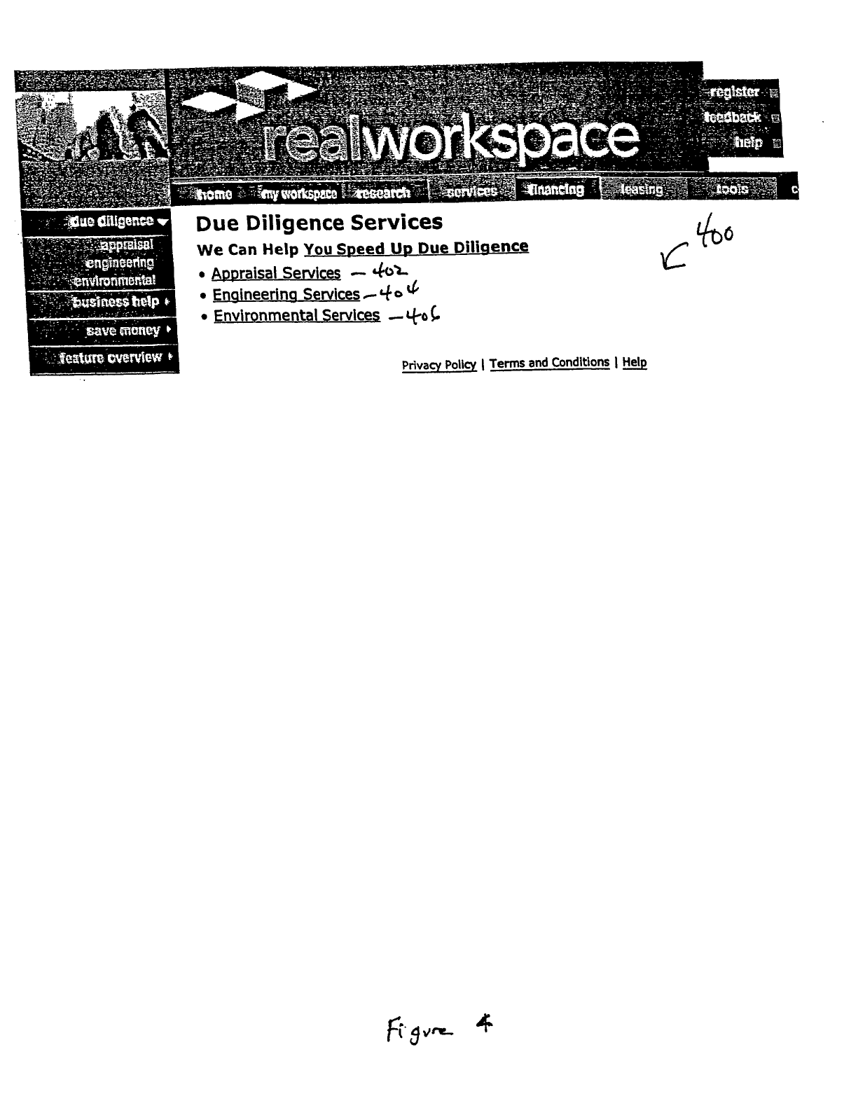

A user of the Web site can navigate through the site by clinking on various links to different pages. FIG. 3A is a process diagram illustrating the functional process of providing various services by the Web site. A user interested in obtaining services related to the commercial real estate industry is offered a choice of multiple services available on the Web site. Selecting the link corresponding to a desired service will provide the user with additional information regarding that service. In step 302, the Web site displays a landing page from which a user can select one of several services provided. In an exemplary embodiment, the Web site contains links for the following service groups: Speed Up Due Diligence, Help You Save Money, Run Your Business More Efficiently, or Quick Feature Overview. A user can select one or several services.

For example, if a user is in the process of purchasing commercial real estate, the user may want to learn as much about the property as possible. The process of learning about the property is often called conducting due diligence. Due diligence services include services to assist one in obtaining information concerning commercial real estate to make an informed decision on the status, both legal and physical, of the property in relation to the purchase, sale, lease, or other acquisition of the property. Due diligence can including verifying the ownership, property boundaries, existence of liens or encumbrances, tax status, condition of the property, value of the property, and whether the property contains or has a history of environmental contamination.

In step 304, the Web site displays a landing page from which the user can select one of three exemplary services relating to Due Diligence: Appraisal Services, Engineering Services, or Environmental Services. By providing access to these services on the Web site, the invention can expedite the due diligence process. Expediting the process can occur by quickly matching a user in need of due diligence services with providers of these services and price quotes for offered services. Thus, a user can contact several service providers at once who offer different services rather than contacting one service provider at a time. The user can quickly choose service providers based on the price quotes and information on the service providers. The ability to contact multiple service providers at once and to obtain a multiple of services at once via the Web site greatly reduces the time spent on acquiring these services using conventional means. Thus, the a user of the Web site can more efficiently and effective manage their commercial real estate property.

In addition to offering a process for expediting the due diligence process, the Web site can also assist a user in saving money. In step 306, a user can select the Help You Save Money link. In response, the Web site displays a plurality of hypertext links that can link the user to various vendors who provide low cost services and products. In one embodiment, the Web site can help a user save money by allowing the user to leverage the large volume purchasing power of the Web site. The Web site can offer links to providers of low cost services and products because the reduced price of the services and products is offset by the increase volume of sales. The Web site can also provide a process by which a user can purchase selected products and services. In one embodiment, the Web site can provide a secure site in which a user can enter credit card information. The Web site can process the credit card order allowing the user to purchase the selected products and services.

The Web site of the present invention also can offer services to assist users of the Web site to efficiently manage their commercial endeavors. In step 308, a user selects Run Your Business More Efficiently, and the Web site responds by displaying a list of hypertext links to vendors providing services designed to assist the user in running her business. Exemplary services that assists a user to efficiently manage her business include services relating to topics such as human resources, obtaining loans, buying or leasing equipment, employee benefits and payroll, obtaining credit, and accounting services. A user of the Web site can manage her business more efficiently by reducing the time spent searching for providers of the specified services because a multitude of services providers are displayed to the user at once. Thus, a user of the Web site can be matched with multiple service providers in less time than using conventional means such as telephone calls. Business problems can be quickly addressed and remedied using the Web site to match users with service providers.

Due Diligence Services

An exemplary process for expediting due diligence using the Web site of the present invention is detailed in FIG. 3B. FIG. 3B is a process diagram of an exemplary process for providing due diligence-related services through Speed Up Due Diligence 304. To access the due diligence services offered by the Web site, a user navigates through the Web site by first accessing the Services link on the web page where the Services link is active. The Services landing page displays links to the services provided by the Web site, and in step 304 the user then selects the Speed Up Due Diligence link. In one embodiment, the Web site displays a landing page with links to the following Due Diligence Services: Engineering Services; Environmental Services; or Appraisal Services. If the user is interested in one or more of these services, the user can select them and the Web site will display information relating to the selected services.

Engineering Services

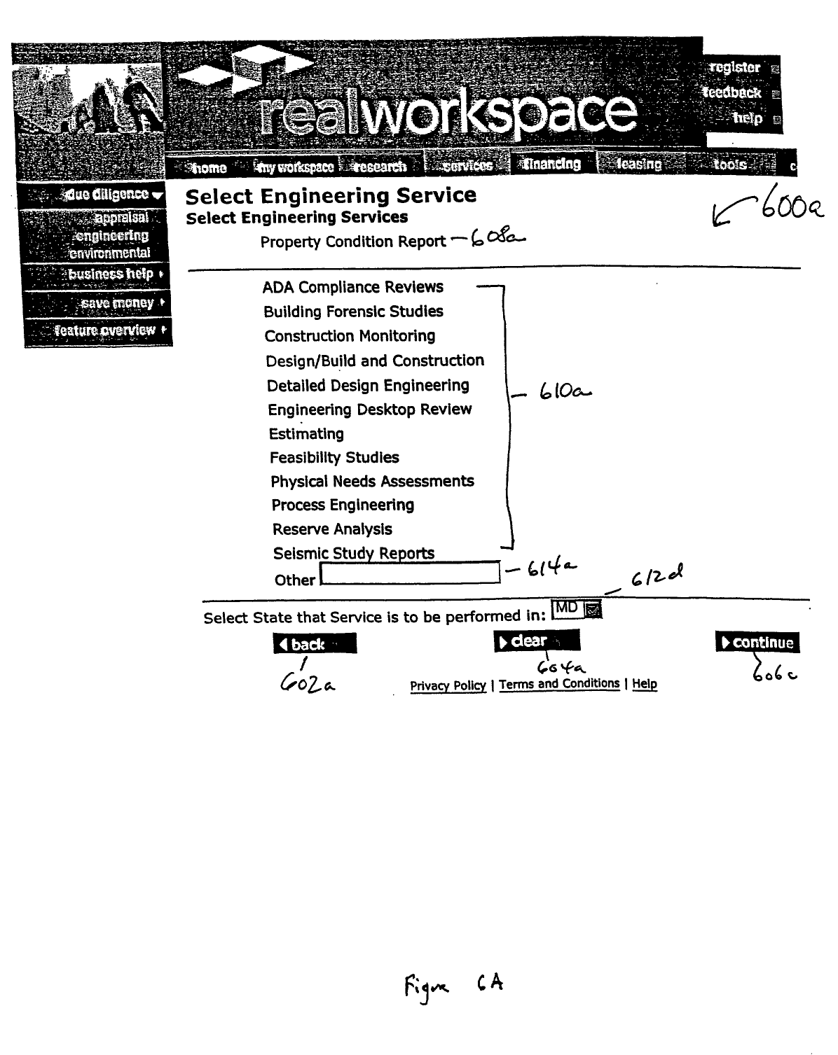

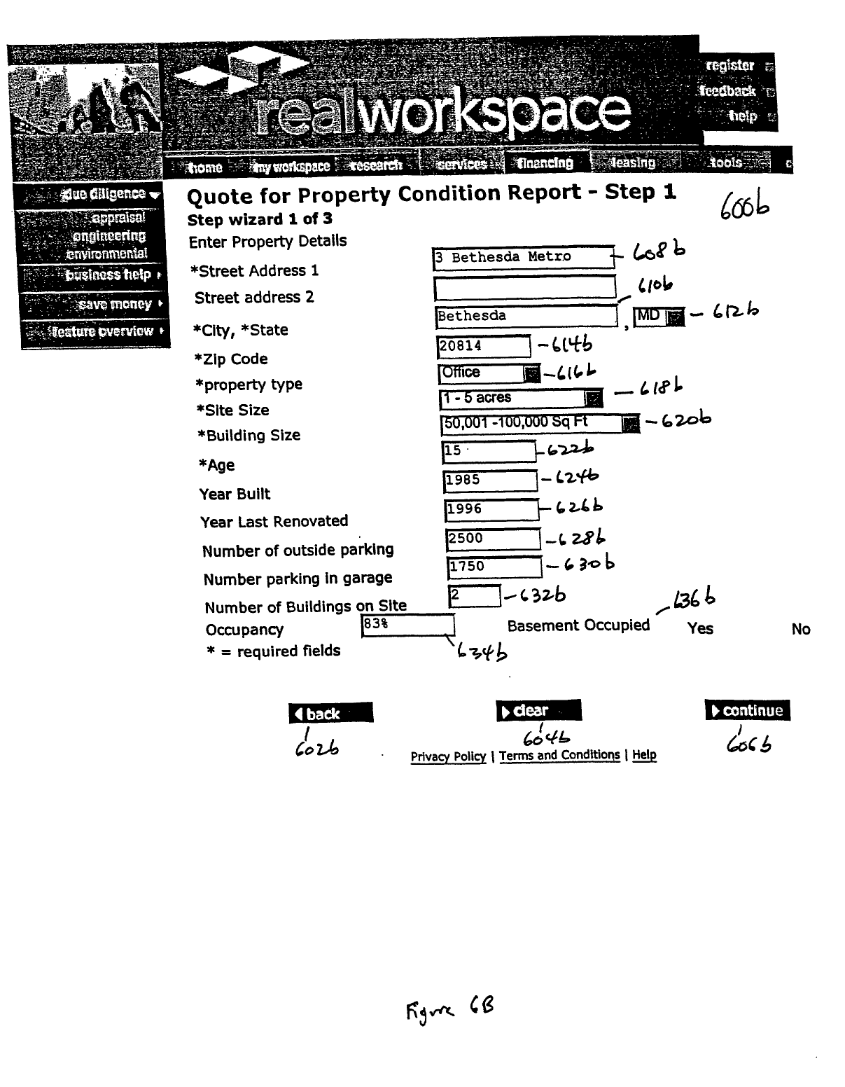

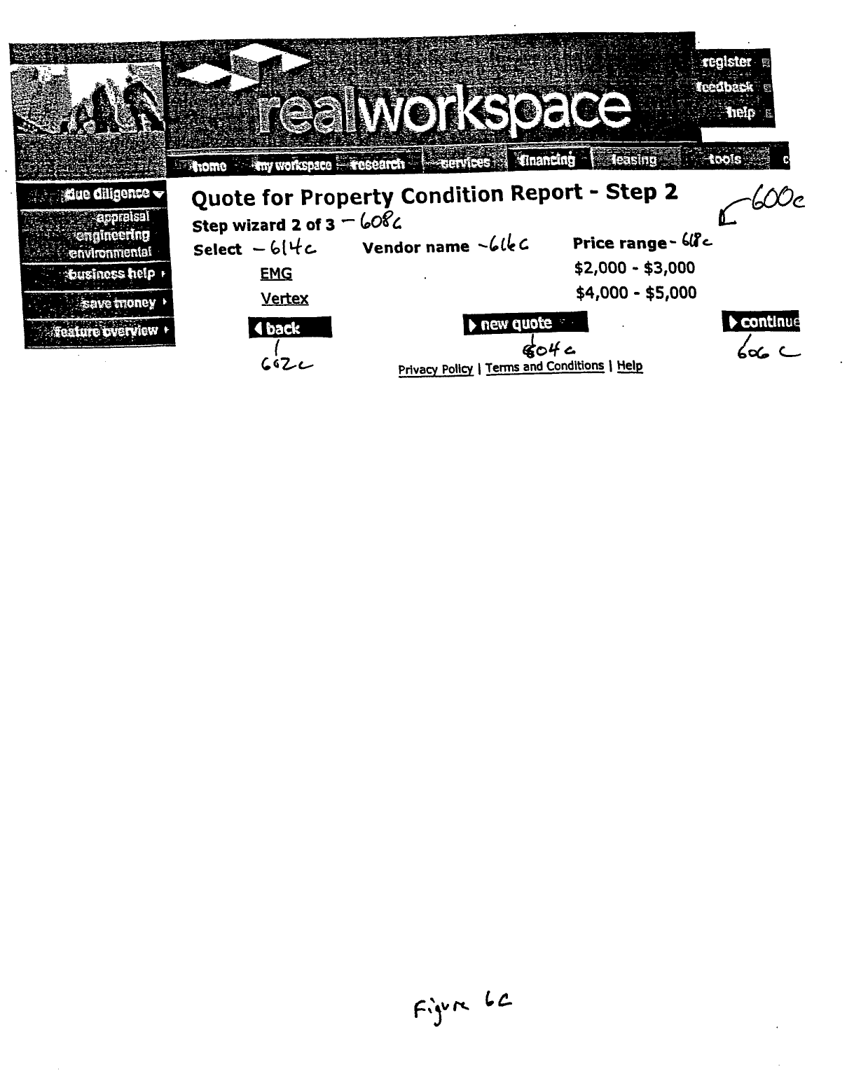

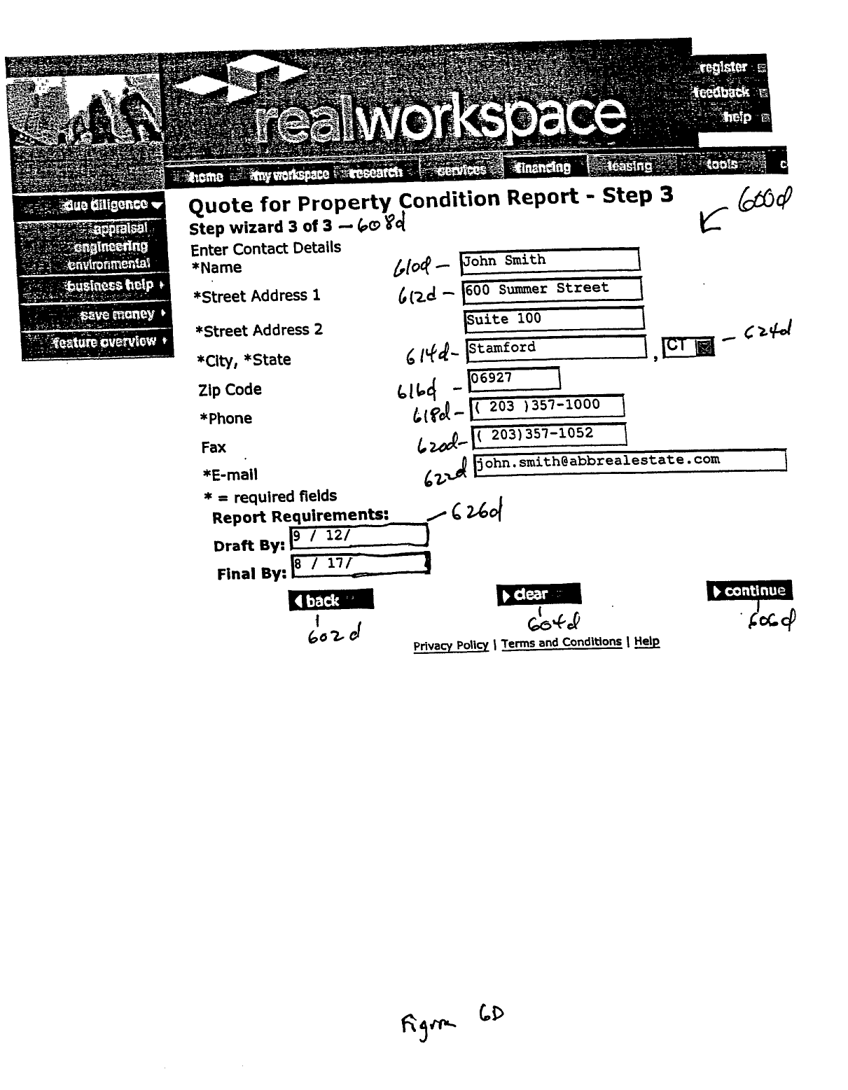

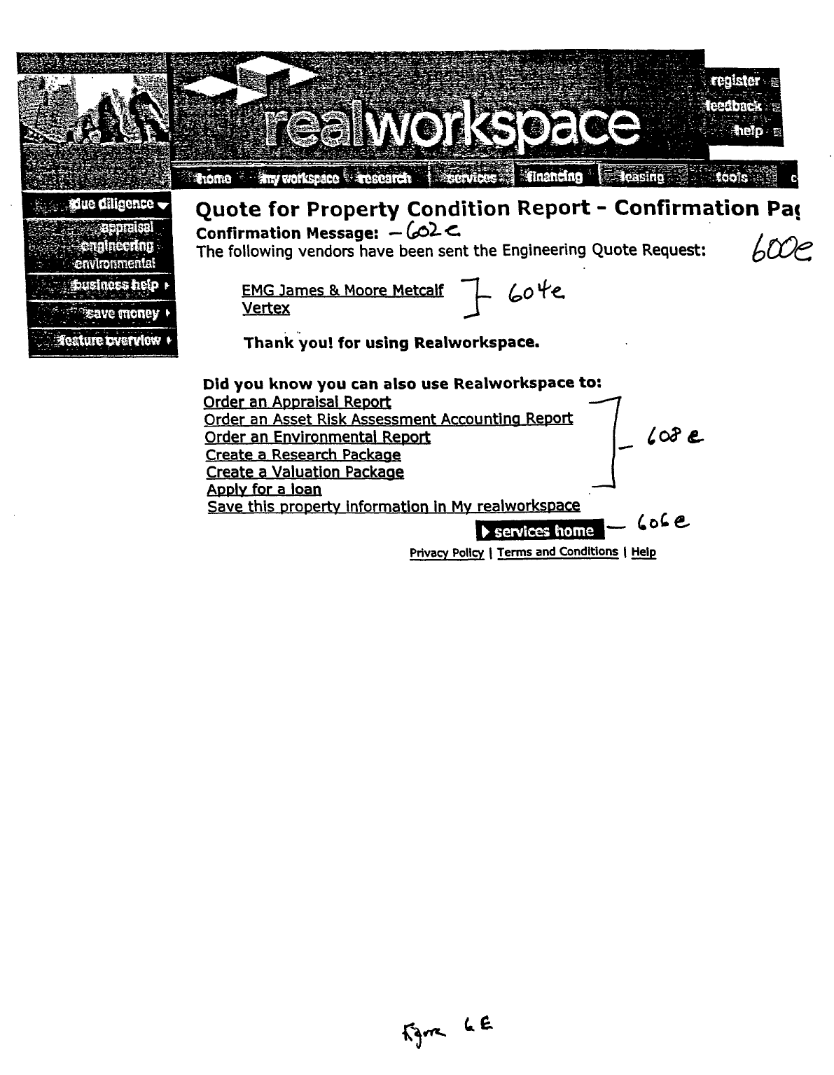

For example, if a user is interested in determining the condition of a property of interest, the user can select the Engineering services link. This link can provide the user with information, a quote, and service providers to obtain a Property Condition Report. A Property Condition Report is an engineering evaluation of the physical condition of the property. A user accesses the Engineering Services section by selecting the Engineering services link. To obtain a Property Condition Report or other engineering service a user first selects the Speed Up Due Diligence section and then selects Engineering Services in step 304.1. In step 304.2, the Web site displays an Engineering Services Landing Page. The Engineering Services section include the following web pages: Select Engineering Services 600a, Generate Soft Quote 600b, Select Engineering Firm 600c, Provide Contact Details 600d, and a Confirmation Page 600e (FIGS. 6a-e). The Web site can also display a navigation aid containing back, clear, and continue buttons.

In step 304.3, the Web site displays a Request Quote Wizard that can assist the user in providing necessary information to obtain a quote for a selected service. A Request Quote Wizard is a series of Web pages containing data fields for required information that the user inputs. These series of pages are presented in a plain, understandable format to assist the user to provide specific information. For example, the address of the property in question must be supplied by the user to identify the property subject of a Property Condition Report. The Request Quote Wizard can comprise multiple web pages. In an exemplary first page of the Request Quote Wizard, the Web site can provide a Property Details form. The Property Details form can have several data entry fields. Exemplary data entry fields can include: Street Address, City, State, Zip Code, Property Type, Site Size, Building Size, Number of Stories, Age, Year Built, Year Last Renovated, Number of outside parking, Number of parking in garage, Number of Buildings on Site, Number of Tenants, Occupancy, and Basement Occupied. A user enters property specific information into the Property Details form. The Web site can also display a navigation aid.

The Web site also provides services that are not strictly related to a commercial real estate property. In step 304.4 the user selects non-property related services displayed on the Select Engineering Service page 600a. Exemplary non-property related services include: ADA Compliance Reviews, Building Forensic Studies, Construction Monitoring, Design/Build and Construction, Detail Design Engineering, Engineering Desktop Review, Estimating, Feasibility Studies, Physical Needs Assessment, Process Engineering, Reserve Analysis, and Seismic Study Reports.

Once a service is selected, a user is then given the option of selecting a service provider that matches the criteria provided by the user and the criteria supplied by the service provider. In step 304.5 the Web site displays a Select Engineering Firm page 600c containing a list of engineering firms that match the user's criteria. The user can select a firm or firms from which to obtain a quote for a particular service by clicking on the designated link.

Because the Web site offers various levels of services the access to which is regulated by the level of subscription purchased by the user, the Web site must determine whether the user has subscribed to a selected offered service. In decision step 304.6, the Web site determines whether a user is unregistered or not logged in. The Web site can ask the user to either register or log in. If the user is not logged in or registered, the Web site can provide the appropriate links or mechanism for the user to log in or register. If the user does not register or log in, the user cannot obtain a quote for a service or product.

In step 304.7, the Web site generates a registration loop to register the user. In step 304.8 the Web site displays the Provide Contact Details page 600d so a registered user can enter contact information. Only registered users who are logged into the Web site can access the Provide Contact Details page. The Provide Contact Details page is a page that lists the user's contact information so that a selected service provider can contact the user directly. The Web site can display pre-populated contact details for registered or logged in users. The contact details can be overwritten by a user if necessary. The Web site can also display Report Requirements for a user to indicate when a draft and final version of a selected report is needed.

When a user clicks the continue button, the Web site automatically submits the user's request with the proper information by e-mail to selected vendors. If a vendor was listed for multiple services and selected multiple times on the Select Engineering Firm page 600c, then the request will be combined into one e-mail for that vendor listing all services requested from that vendor. Each vendor can provide one main and two alternative e-mail addresses where the request can be sent. The Web site can automatically send the copies with no further user intervention. Vendors can be required by contract to respond to the user's request via e-mail within a specified number of days. The Web site automatically sends a copy of every quote request and vendor response to a dedicated Web site e-mail address at the call center for tracking and managing the engineering services process. This copy does not include pricing information from the vendor, but only indicates that an e-mail response was sent.

Once a request for a quote is submitted, the Web site generates a Confirmation Page 600e in step 304.9. The Confirmation Page can include the following components: Descriptive Copy, Confirmation Message 602e, Hyperlinks 604e and 608e, and Services Home button 606e. Descriptive Copy is a static text description of the features and benefits of the current step in the process. The Confirmation Message 602e indicates the property information, the vendors sent the Property Condition Report request. and thanks the user for using the Web site. The hyperlinks can be to other Web site sections providing suggestions to the user for other Web site features the user may find valuable. Hyperlinks 608c link the user to the following exemplary sections: Order an Appraisal Report, Order an Asset Risk Assessment Accounting Report, Order an Environmental Report, Create a Research Package, Create a Valuation Package, Apply for a Loan, Save this information in My Realworkspace.

In one embodiment, users proceed through the Engineering Services section in a specific sequence and follow the steps in a particular order because subsequent pages require information entered on previous pages. All pages in the Engineering Services section can include one or more logical navigational schemes (such as a left navigation bar) that will allow a user to link between pages and identify what step she is on in the process at any time. Navigation between pages may be restricted based on defined business rules. For example, a user may not request a firm quote before she has completed and saved the previous step in the process.

Engineering Services Web Pages

In an exemplary embodiment, the Engineering Services section includes the following web pages: Select Engineering Services 600a, Generate Soft Quote 600b, Select Engineering Firm 600c, Provide Contact Details 600d, and a Confirmation Page 600e (FIGS. 6a-e). The Web site can also display a navigation aid containing back, clear, and continue buttons.

The Select Engineering Services page 600a includes the following components: Description of Engineering Services, Hyperlinks to service provider information pages, Engineering Services checkbox with state 612a selection, back 602a, clear 604a, and continue buttons 606a.

The Description of Engineering Services is a static text description of Engineering Services and how they may be of value to the user. The hyperlinks to vendor information pages provide access to pop-up information about participating engineering firms. Logos or hyperlinked image maps link the user to an engineering firm information page in a reduced size browser instance or daughter window. The service provider can provide creative content such as logos and vendor information for the Web site. This information is formatted in a Web site specific manner. Users close the daughter window and return to the active Select Engineering Services page 600a by selecting the close window button at the bottom of the window. The Engineering Services checkbox enables a user to select a Property Condition Report or other engineering service.

FIG. 6a is an exemplary web page for Select Engineering Services 600a that the Web site displays in step 304.2. In one example, a user selects Property Condition Report 608a to obtain a soft quote for obtaining an evaluation of the condition of a property. Users can also select from the following list of non-property related engineering reports 610a to request vendors to send information about those reports without obtaining a soft quote: ADA Compliance Reviews, Building Forensic Studies, Construction Monitoring, Design/Build and Construction, Detail Design Engineering, Engineering Desktop Review, Estimating, Feasibility Studies, Physical Needs Assessment, Process Engineering, Reserve Analysis, and Seismic Study Reports. Users can select one or more reports or services using a checkbox feature or other similar selection method. Users must select at least one report or service before selecting the continue button 606a at the bottom of the page to proceed. For non-property specific reports, vendors can be matched based on service and state.

The “State” field 612a is a user selected field for entering the state in which the property is located. Back 602a, clear 604a, and continue 606a buttons allow a user to navigate to different pages on the Web site. Clicking the back button 602a returns the user to the previous page. Clicking the clear button 604a clears all the selections the user has made, but the user remains on the Select Engineering Services page 600a. Clicking the continue button 606a moves the user to the next step of the Engineering Services process and opens the Quote for Property Condition Report page 600b if Property Condition Report 608a is selected, or opens Select Engineering Firm page 600c if Property Condition Report 608a is not selected.

FIG. 6b is an exemplary Quote for Property Condition Report 600b display page. A user enters property information and requests the Web site to generate a cost estimate for a Property Condition Report based on parameters provided by the engineering vendors. The Quote for Property Condition Report 600b can be restricted to only open if the user selected the Property Condition Report as one of her choices on the Select Engineering Services page 600a. If a user does not select Property Condition Report as one of her choices, the Web site can skip this page and immediately open the Select Engineering Firm page 600c (FIG. 6c). In one embodiment, the Quote for Property Condition Report 600b includes the following components: Description of Three-Step Process, Step Wizard, Enter Property Details, Select Filtering Options, Back 602b, Clear 604b and Continue 606b buttons.

The “Description of the Three-Step” process is a static text page of the three-step process a user can follow to obtain a Property Condition Report. This section is a read-only section and requires no user interaction. The Step Wizard provides a static text description of a Request Firm Quote page and the steps required by a user to follow to complete the page. This section is also a read-only section and requires no user interaction.

The Property Details section of 600b allows a user to enter property-specific information to obtain an accurate soft quote/estimate. If the state 612a entered on the Select Engineering Services page 600a is the same as the stored Current Property, then the Web site populates the Property Details with the data from the stored Current Property. If the state 612a entered on the Select Engineering Services page 600a is not the same as in the stored Current Property, then the Property Details fields is empty, except that the state field can be populated with the state entered in Select Engineering Services page 600a. The Property Details section has several data entry fields. Exemplary data entry fields can include: Street Address 608b, City 610b, State 612b, Zip Code 614b, Property Type 616b, Site Size 618b, Building Size 620b, Number of Stories, Age 622b, Year Built 624b, Year Last Renovated 626b, Number of outside parking 628b, Number of parking in garage 630b, Number of Buildings on Site 632b, Number of Tenants, Occupancy 634b, and Basement Occupied 366b.

Street Address 608b is a user entered field for entering the primary street address where the property is located. Allowable values can be any alpha numeric or extended ASCII character.

City 610b is a user entered field for entering the city where the property is located.

State 612b is a user entered field for entering the state where the property is located. Values are obtained from a property type pull-down list maintained by the Web site.

Zip Code 614b is a user entered field for entering the property's zip code.

Property Type 616b is a user selected field for entering the property/collateral type for the property in question. Values are obtained from a property type pull-down list maintained by the Web site. Exemplary property types include: industrial-single tenant, industrial-multi tenant, multi-family, office, retail, etc.

Site Size 618b allows a user to enter the lot size of the property. Values are obtained from a pull-down list maintained by the Web site. Exemplary table values include: less than one acre, one to five acres, five to ten acres, greater than ten acres.

Building Size 620b allows a user to enter the building square footage floor space, the number of units, or the number of tenants depending on the property type selected. Once the user selects the property type above, the building size field is generated based on the following business rules:

If property type=industrial, then display the following selectable values: less than or equal to 50,000 square feet, 50,001 to 300,000 square feet, greater than 300,000 square feet.

If property type=multi-family, then display the following selectable values: less than 30 units, 31 to 100 units, 101 to 300 units, 301 to 500 units, greater than 500 units.

If property type=office, then select the following selectable values: single-tenant, 2 to 10 tenants, 11 to 30 tenants, 31 to 60 tenants, greater than 60 tenants.

If property type=retail and subtype=neighborhood shopping center, then display the following selectable values: less than 20,000 square feet, 20,000 square feet or greater.

If property type=retail and subtype=does not neighborhood shopping center, then display the following selectable values: less than or equal to 100,000 square feet, greater than 100,000 square feet.

If property type=other, then display the following selectable values: single-tenant, 2 to 10 tenants, 11 to 30 tenants, 31 to 60 tenants, greater than 60 tenants. Values can be obtained from pull-down lists maintained by the Web site.

Number of Stories allows a user to enter the number of stories of the building. Values are obtained from a pull-down list maintained by the Web site. Initial table values include the following: single-story, 2 to 5 stories, 6 to 10 stories, 10 to 25 stories, greater than 25 stories.

Age 622b provides a place for the user to enter the age of the building in years.

Year Built 624b is a user entered field for entering the year the building was originally completed. Allowable values are any integer from 0 to 9. The field length is four characters. The Web site includes the validation mechanism to insure the year entered is valid and will display an error message if the year entered is not valid.

Year Last Renovated 626b is a user entered field for entering the year the building was last renovated. The allowable values are any integer from 0 to 9. The field length can be four characters. The Web site includes a validation mechanism to insure the year entered is valid and will display an error message if the year entered is not valid.

Parking allows the user to indicate whether or not there is parking available on-site, as well as the number of available spaces. Number of outside parking 628b is a user entered field for entering the approximate number of outside parking spaces available. Allowable values are any integer from 0 to 9. Number of parking in garage 630b is a user entered field for entering the approximate number of garage parking spaces available. Allowable values are any integer from 0 to 9.

Number of Buildings on Site 632b is a user entered field for entering the number of distinct buildings on the site. Allowable values are any integer from 0 to 99.

Number of tenants allows the user to enter the approximate number of tenants currently in the user's building. Values are obtained from a pull-down list maintained by the Web site. Initial table values include the following: single-tenant, 2 to 10 tenants, 11 to 30 tenants, 31 to 60 tenants, greater than 60 tenants. Is Basement Occupied is a user selected button that allows the user to indicate if the basement is occupied by a tenant.

Occupancy 634b is a user entered field for entering the percentage occupancy of the building.

Filtering Options allow a user to limit the soft quotes returned to those engineering firms approved by the particular lender. The user can select only one lender from a pull-down list. Values of the list are maintained by the Web site. Selecting a single lender can be possible using standard windows and mouse commands, such as control, left mouse click.

Basement Occupied 336b is a Yes or No field for a user to indicate whether of not the basement of a building is occupied.

Back 602b, clear 604b, and continue 606b buttons allow the user to navigate through the Engineering Services process, or to reset the selections on the current page and start over. Clicking the back button 602b returns the user to the previous page. Clicking the clear button 604b resets all selected and entered items so that the user may reenter if she wishes to start over on the Quote for Property Condition Report page 600b. Selecting the continue button 606b allows the user to move to the next step in the Engineering Service Process and opens the Select Engineering Firm page 600c of FIG. 6c.

FIG. 6c is an exemplary Select Engineering Firm web page 600c. When the user selects the continue button 606b on the Quote for Property Condition Report 600b, the Web site evaluates the user's input and dynamically generates the Select Engineering Firm page 600c and table. For property specified services, vendors are displayed based on the following parameters: service provided, state, property type, subtype, site size, building size. For non-property specific services, vendors are displayed based on the following parameter: service provided, and state. The vendors are grouped under the services selected on Select Engineering Services page 600a with each vendor being listed under each applicable service. The heading for each group includes the name of the service. Output from filtering options allows approved vendors to be designated as “preferred” and the rest on a “other” list. When no matches can be found between vendors and the services requested, a message stating no match found is displayed.

The Select Engineering Firm page 600c includes the following exemplary components: Descriptive Copy, Step Wizard 608c, Select Checkbox, Vendor Name 616c, Price Range 618c, and back 602c, new quote 604c, and continue 606c buttons. The table is generated in alphabetical order by vendor name. A user clicks on a table heading 616c-618c to sort the list in ascending order on that header, or a second time to sort in descending order. For example, if the user wants to sort the list by Price Range 618c, she can click once on the Price Range 618c table head to automatically sort the list from lowest to highest price. Clicking on the header a second time will sort the list from highest to lowest price.

Descriptive Copy is a static text description of the features and benefits of the current step in the process. This section is a read-only section and requires no user interaction. This section can also indicate that only vendors selected will return results.

Step Wizard 608c provides a static text description of the Select Engineering Firm Page and the steps required for a user to complete the page. This section is a read-only section and requires no user interaction.

The Select checkbox enables a user to select from which vendor she would like to receive a firm quote and contract. Headings under the vendor list can be services selected. Vendors can be sorted and listed by the services selected.

Vendor Name 616c provides a list of the engineering vendors that can provide services to the user based on the inputs the user and the vendor have provided. Vendor names can be hyperlinked. Clicking on the hyperlink opens up an engineering firm pop-up information page in a reduced size browser instance. In one exemplary embodiment, no browser navigation features or URL address window are available in the new browser instance. The vendor can supply all vendor information to the Web site in a format specific to the Web site.

Price Range 618c provides the estimated price for a Property Condition Report based on the user's input and cost information previously supplied by the vendors to the Web site.

Back 602c, new quote 604c, and continue 606c buttons allow the user to navigate through the engineering services process or to obtain a new quote for engineering services. Clicking a back button 602c returns the user to the Quote for Property Condition Report 600b if Property Condition Report was selected, or to the Select Engineering Services page 600a if only non-property services were selected. All fields can retain the previously input values so the user can make selected changes without reentering all the information on the page. Clicking the new quote button 604c returns the user to the Select Engineering Services page 600a. All fields are cleared so the user may request another soft quote. Clicking the continue button 606c moves the user to the next step in the Engineering Service process and open the Provide Contact Detail Page 600d of FIG. 6d.

FIG. 6d is an exemplary Provide Contact Details web page 600d. The Provide Contact Details web page 600d includes the following components: Descriptive Copy, Step Wizard 608d, Contact Details, Report Requirements 626d, Back 602d, Clear 604d, and Continue 606d buttons.

Descriptive Copy is a static text description of the features and benefits of the current step in the process. This section is a read-only section and requires no user interaction.

Step Wizard 608d provides the static text description of the provide contacts details page and the steps required for a user to complete the page. This section is a read-only section and requires no user interaction.

Contact Details contains several fields of information which can be populated with the registered user's default information. The default information can be overwritten if needed.

Contact information must be entered into the Provide Contact Details Form to complete the request for a firm quote and contract from the engineering vendors. Exemplary fields in the provide contact details form can include: Name 610d, Street Address 612d, City 614d, State 624d, Zip Code 616d, Phone 618d , Fax 620d, E-mail 622d, and Report Requirements 626d.

Name 610d is a user entered field for entering the name of the person who should receive the firm quote or contract from the engineering vendors. Allowable values are any alphanumeric or extended ASCII character.

Street Address 612d is a user entered field for entering the primary street address where the vendors should send the firm quote or contract. Allowable values are any alphanumeric or extended ASCII character.

City 614d is a user entered field for entering the city of the contact person.

State 624d is a user selected field for entering the contact person's state.

Zip Code 616d is a user entered field for entering the contact person's zip code.

Phone 618d is a user entered field for entering the contact person's area code and phone number, should the vendor have questions or need additional information.

Fax 620d is a user entered field for entering the contact person's fax number.

E-mail 622d is a user entered field for entering the contact person's e-mail address to receive electronic replies to her requests.

Report Requirements 626d are two user entered fields for indicating when the user needs the draft and final property condition or other selected engineering report. The draft and final report requirements fields have visibly separate and identified areas for entering the month, date and year. The Web site includes the necessary logic to determine if the date entered is valid. If the date entered is not valid, the Web site returns an error message and require the user to reenter the data.

Back 602d, clear 604d, and continue 606d buttons allow the user to navigate through the engineering services process, or to obtain a new quote for engineering services. Clicking the back button 602d returns the user to the Select Engineering Firm page 600c. Clicking the clear button 604d clears the fields in page 600d. All fields are cleared. Clicking the continue button 606d, or submit request button, submits the user's request to the selected vendors and opens the Confirmation Page 600e.

FIG. 6e is an exemplary Confirmation Page 600e. The Confirmation Page 600e includes the following components: Descriptive Copy, Confirmation Message 602e, Hyperlinks 604e and 608e, and Services Home button 606e.

Descriptive Copy is a static text description of the features and benefits of the current step in the process. This section is read-only and requires no user interaction.

Confirmation Message 602e indicates the property information, the vendors sent the Property Condition Report request, and thanks the user for using the Web site. The Confirmation Page 600e also provides hyperlinks to other Web site sections, thus providing suggestions to the user for other Web site features the user may find valuable.

Hyperlinks 608e link the user to the following exemplary sections: Order an Appraisal Report, Order an Asset Risk Assessment Accounting Report, Order an Environmental Report, Create a Research Package, Create a Valuation Package, Apply for a Loan, Save this information in My Realworkspace. Clicking the hyperlink can open the appropriate Web site page. The user is prompted for a name for the information to save in my Realworkspace and notified if this name is overriding an existing name. All fields that the user has entered or filled-in during the engineering services process automatically populate the appropriate fields in the Web site section to which the user links. Users can always use the back button to return to the previous location. A Services Home button 606e is also included that sends the user to the Services Home page.

Environmental Services

Another aspect of due diligence involves determining the extent of environmental contamination on a property. To assist a user in conducting this aspect of the due diligence process, the Web site of the present invention provides environmental services to evaluate environmental contamination. The Environmental Services section incorporates a multi-step process that, in one embodiment, enables a registered user to obtain a Phase I Federal National Mortgage Association (FNMA)/Federal Home Loan Mortgage Corporation (FHLMC) Protocol Environmental Assessment Report from an environmental firm. A user first enters basic information concerning the property in question. The Web site then generates quotes and/or estimates for obtaining the Phase I Report from various vendors, based on specific information previously collected from these vendors. A user then selects one or more vendors and the Web site generates an e-mail to those firms to request a firm quote and contract. The environmental firms then contact the user directly via e-mail, telephone, facsimile and/or standard mail to provide those services. Users can also request other non-property specific information from environmental firms. Exemplary non-property specific information include: Phase II Services 710a—Asbestos Assessment, Lead-Based Paint Assessment, UST Management, Groundwater Surveys, Soil Management, Operations and Maintenance Programs; Phase III Services 712a—Asbestos Screen, Lead-Base Paint Screen, Transactions Screen, Governmental Search and Interpretation, Report Review and Opinion. In these situations, users are not required to enter a property's specific information and a soft quote will not be generated. Instead, the user can immediately proceed to the Select Environmental Firm screen 304.14. A user can select one or more vendors and generate an e-mail to those firms to request the information. The environmental firms then contact the user directly via e-mail, telephone, facsimile and/or standard mail to provide the information.

A user accesses the environmental services provided by the Web site by clicking on the Environmental Services navigation link on the Speed Up Due Diligence Landing page 400 in step 304.10. The Select Environmental Services Landing page 700a will then appear. The Environmental Services Section includes the following web pages: Select Environmental Services 700a, Request Firm Quote 700b, Select Environmental Firm 700c, Provide Contact Details 700d, and Confirmation Page 700e. The Web site automatically saves and posts user entered information into the Web site database when the page is completed and the continue button is clicked. The Web site tracks this information so that if the user is inadvertently booted from the Web site, she may recover the previously entered data and continue at the last saved point in the process without having to start over.

In step 304.11, the Web site displays an Environmental Services Landing Page that lists offered services. A user selects a specific service such as a Federal National Mortgage Association (FNMA)/Federal Home Loan Mortgage Corporation (FHLMC) Protocol Environmental Assessment Report or multiple services. In step 304.12, the Web site displays a Request Quote Wizard. The Request Quote Wizard can comprise multiple web pages directing the user through the process to obtain a quote from an Environmental Service provider. In on embodiment, the first page of Request Quote Wizard is a Quote for Phase I Report page 700b. A user enters property information in a Property Details Form and requests the Web site to generate a cost estimate for environmental services based on parameters provided by the environmental vendors. The Quote for Phase I Report page 700b can only opened if a user has selected the Phase I Report as one of her choices in the Select Environmental Services page 700a If a user does not select a Phase I Report as one her choices, the Web site can skip this page and immediately open the Select Environmental firm page 700c. The Web site can also list other options the user can select.

In addition to property specific services, the Web page provides environmental services that are not related to a specific property. In step 304.13 a user selects a non-property related environmental service. Exemplary non-property specific information include: Phase II Services 710a—Asbestos Assessment, Lead-Based Paint Assessment, UST Management, Groundwater Surveys, Soil Management, Operations and Maintenance Programs; Phase III Services 712a—Asbestos Screen, Lead-Base Paint Screen, Transactions Screen, Governmental Search and Interpretation, Report Review and Opinion.

In step 304.14 the Web site evaluates the user's input and dynamically generates the Select Environmental firm Page 700c and table. Matching criteria to display the vendors is as follows: for property-specific services parameters such as service provided, state, property type, subtype, site size, building size can be used. For non-property specific services: service provided and state parameters are used. The vendors are grouped according to selected environmental services, with each vendor listed under each applicable service. The heading for each group includes the name of the service. Output from filtering options shows approved vendors as “preferred” and the rest in a “other” list. When no matches can be found the Web site displays a message stating that no matches can be found.

Because access to specific services offered by the Web site are restricted to users who have purchased a various levels of subscriptions, the Web site must determine whether a user is registered or logged in. In decision step 304.15 the Web site determines whether a user is registered with the Web site or logged on. If a user who is unregistered or not logged in attempts to access a restricted page, the Web site can ask the user to either log in or register in step 304.16. The Web site provides the appropriate links or mechanism for the user to log in or register. In step 306.16, the Web site can also generate a registration loop to register the user.

In step 304.17, the Web site displays the Web site displays the Provide Contact Details page 700d so a registered user can enter contact information. Only registered users who are logged into the Web site can access the Provide Contact Details page. The Provide Contact Details page is a page that lists the user's contact information so that a selected service provider can contact the user directly. The Web site can display pre-populated contact details for registered or logged in users. The contact details can be overwritten by a user if necessary. automatically submits the user's request with property information by e-mail to the selected vendor once the user has provide Contact Details. The Web site can automatically submit a users request for a quote once the Contact Details information is supplied.

If a vendor was listed for multiple services and selected multiple times on the Select Environmental Firm page 700c the request can be combined into one e-mail for that vendor, listing all services requested from that vendor. Each vendor can provide one main or two alternate e-mail addresses where the request should be sent. The Web site can automatically send the copies with no further user intervention. Vendors can be required by contract to respond to the user request by e-mail within one business day. The Web site automatically sends a copy of every quote requested and vendor response to a dedicated Web site e-mail address at the call center for tracking and managing the environmental services process. This copy cannot include pricing information from the vendor but only indicates an e-mail response was sent.

In step 304.18 the Web site generates a Confirmation Page 700e which includes the following components: Descriptive Copy, Confirmation Message 702e, Hyperlinks 704e and 708e, and a Services Home button 706e. The Descriptive Copy is a static-text description of features and benefits of the current step in the process. This section is a read-only section and require no user interaction. Confirmation Message 702e indicates the property information and which vendors have been sent the Environmental Services Report Request, and hyperlinks 704e and 708e. The Web site also displays links to other services available on the Web site.

Users proceed through the Environmental Services in a specified sequence and follow the steps in that sequence. Subsequent pages require information entered on previous pages. All 10 pages in the environmental services section can include one or more navigational schemes that will allow a user to link between pages and identify what step she is on in the process at any time. Navigation between pages may be restricted based on defined business rules. For example, a user may not request a firm quote before the user has completed and saved the previous steps in the process.

Environmental Services Web Pages

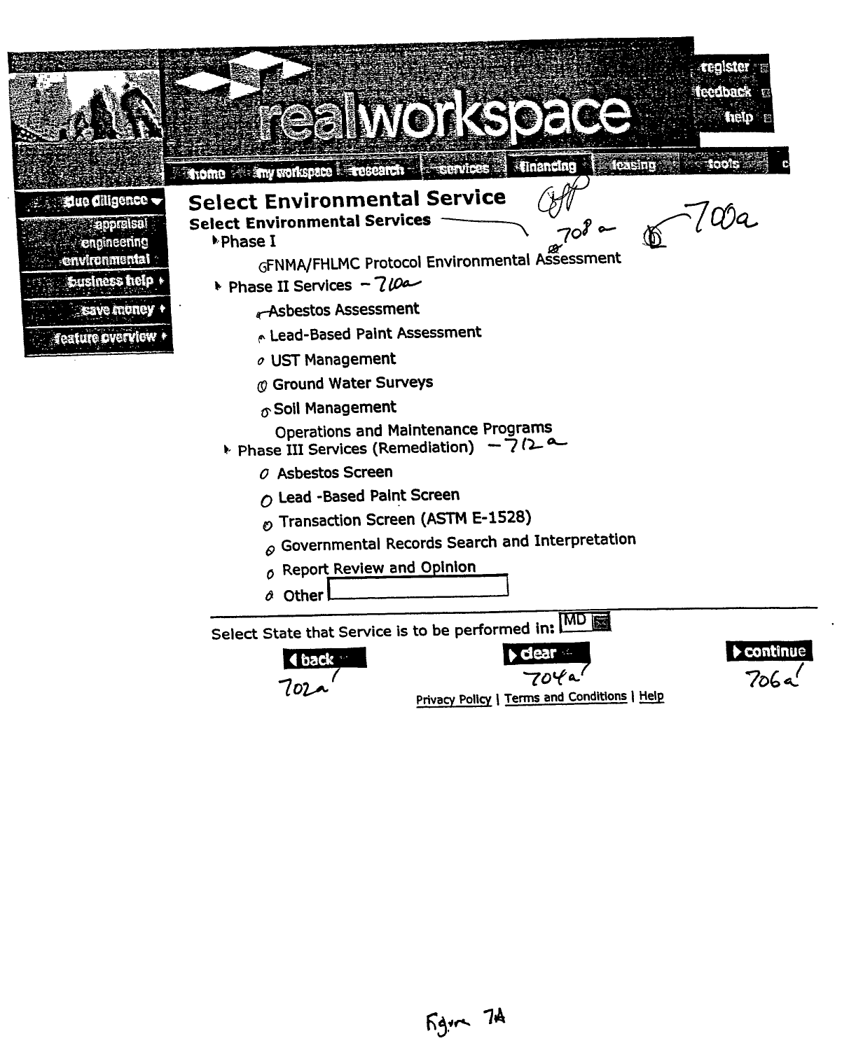

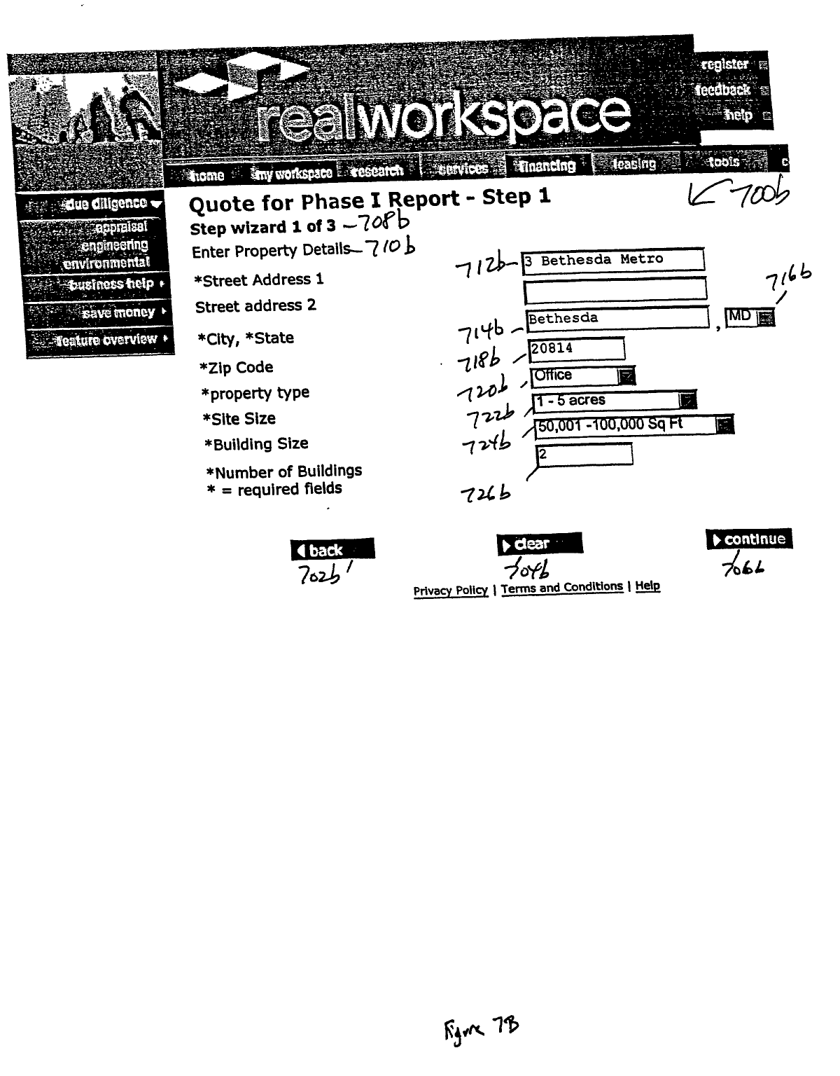

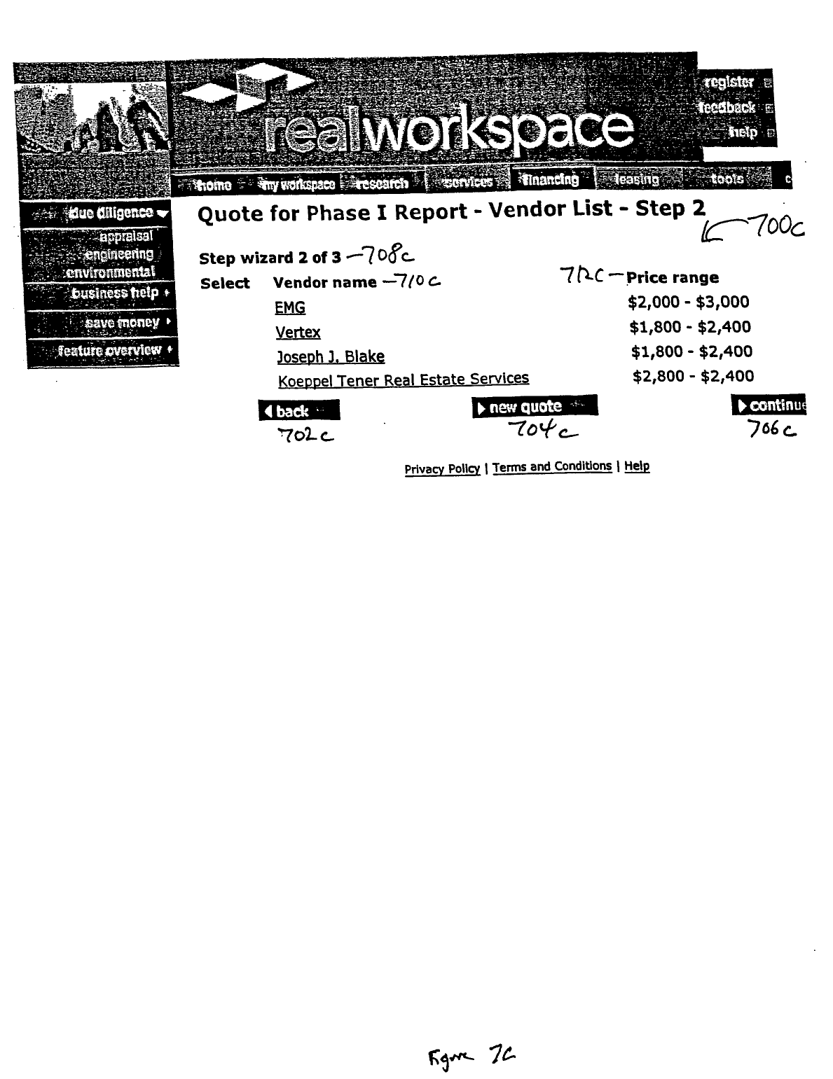

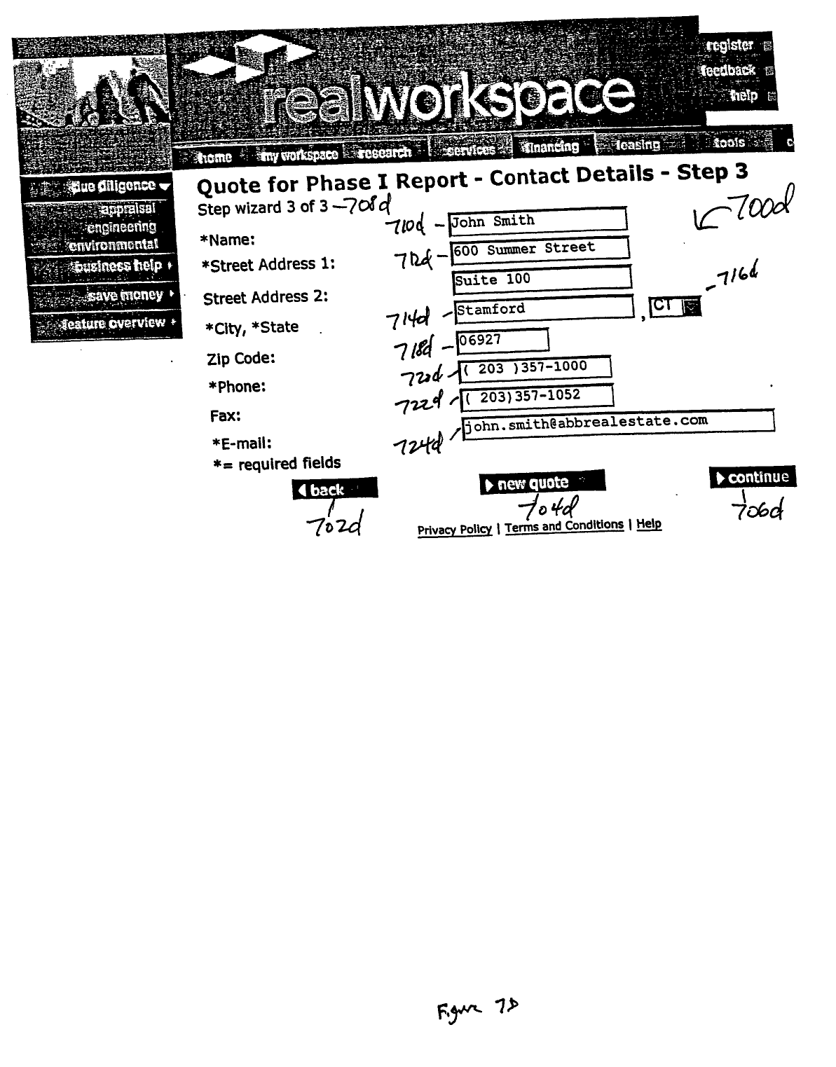

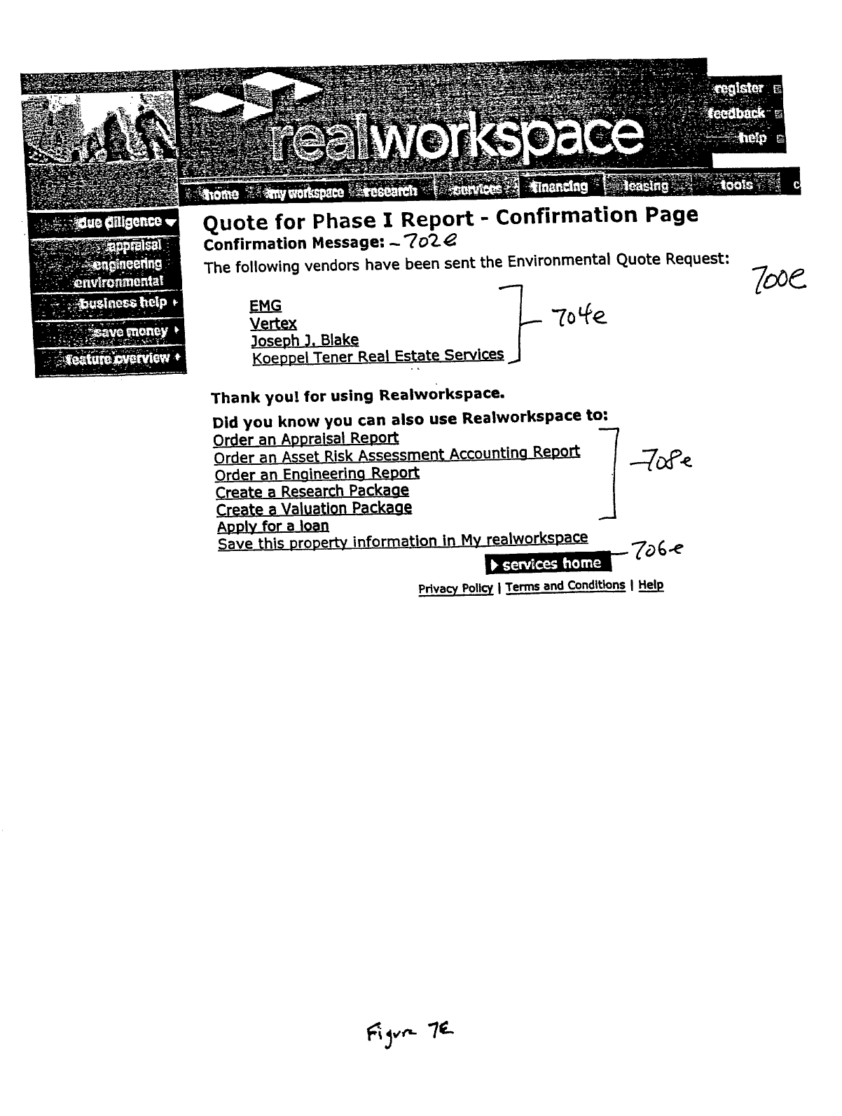

FIG. 7a is an exemplary Select Environmental Services page 700a. The Select Environmental Services page 700a includes the following components: Description of Environmental Services, Hyperlinks to service provider information pages, Environmental Services checkbox, Back 702a, Clear 704a, and Continue 706a buttons.

Description of Environmental Services is a static text description of environmental services and how they may be of value to the user. This section is a read-only section and requires no user interaction.

Hyperlinks to service provider information pages provide access to pop-up information about the participating environmental firms. Logos or hyperlinked image maps link the user to an environmental firm information page in a reduced size browser instance or daughter window. In one exemplary embodiment, no browser navigation features or URL address window is available. The participating service provider can provide all creative content such as logos and vendor information in a format that is specified by the Web site. The user can close the daughter window and return to the active Select Environmental Services page 700a by clicking on the close window button at the bottom of the window.

The Environmental Services checkbox enables a user to select a Phase I Report or other environmental service the user is interested in obtaining. The Web site presents the user with a list of environmental services and reports that are offered through the Web site. For example, the user can select a Phase I Report FNMA/FHLMC Protocol Environmental Assessments 70a. Users can also select the following list of non-property-related environmental reports and services to request vendors to send information about these reports: Phase II Services 710a—Asbestos Assessment, Lead-Based Paint Assessment, UST Management, Groundwater Surveys, Soil Management, Operations and Maintenance Programs; Phase III Services 712a—Asbestos Screen, Lead-Base Paint Screen, Transactions Screen, Governmental Search and Interpretation, Report Review and Opinion. Users can select one or more reports or services using a checkbox feature or other similar selection method. Users must select at least one report or service before clicking the continue button at the bottom of the page to proceed. For non-property specific services, vendors can be matched on service and state basis. State can be a user selected field for entering the state in which the property is located. Values can be obtained from a pull-down list maintained by the Web site.

Back 702a, clear 704a, continue 706a buttons allow the user to navigate to different pages on the site. Clicking the back button 702a returns the user to the previous page. Clicking the clear button 706a clears all the selections the user has made, but the user remains on the Select Environmental Services page 700a. Clicking the continue button 706a moves the user to the next step in the environmental services process and open the Quote for Phase I Report 700b, if a Phase I Report is selected or open Select Environmental firm page 700c if the Phase I Report is not selected.

FIG. 7b is an exemplary Quote for Phase I Report web page 700b. The Quote for Phase I Report web page 700b includes the following components: Description of Three-step Process, Step Wizard 708b, Property Details, Select Filtering Options, Back 702b, Clear 704b, and Continue 706b buttons. Description of the three-step process is a static test description of the three-step process a user can follow to obtain a Phase I Report. This section is read-only and requires no user interaction.

The Step Wizard 708b provides a static text description of the request firm quote page and the steps required for a user to complete this page. This section can be a read-only section and requires no user interaction.

Property Details allows the user to enter property-specific information to obtain an accurate soft quote/estimate. If the state entered on the Select Environmental Services page 700a is the same as the stored Current Property, then the Web site can populate the property details with the data from the stored current property. If the state entered on the Select Environmental Services page 700a is not the same as stored in the current property, then the property details field should be empty, except that the state field can be populated with the state entered in the Select Environmental Services page 700a. The Property Details can have several data entry fields. Exemplary data entry fields can include: Street Address 712b, City 714bb, State 716b, Zip Code 718b, Property Type 720b, Site Size 722b, Building Size 724b, and Number of Buildings 726b.

Street Address 712b is a user entered field for entering the primary street address where the property is located. Allowable values are any alpha numeric or extended ASCII character.

City 714b is a user entered field for entering the city where the property is located.

State 716b is a user entered field for entering the state where the property is located. Values are obtained from a property type pull-down list maintained by the Web site.

Zip Code 718b is a user entered field for entering the property's zip code. Property Type 616b is a user selected field for entering the property/collateral type for the property in question. Values are obtained from a property type pull-down list maintained by the Web site. Exemplary property types include: industrial-single tenant, industrial-multi tenant, multi-family, office, retail, etc.

Site Size 722b allows a user to enter the lot size of the property . Values ar e obtained from a pull-down list maintained by the Web site. Exemplary table values include: less than one acre, one to five acres, five to ten acres, greater than ten acres.

Building Size 724b allows a user to enter the building square footage floor space, the number of units, or the number of tenants depending on the property type selected. Once the user selects the property type above, the building size field can be generated based on the following business rules:

If property type=industrial, then display the following selectable values: less than or equal to 50,000 square feet, 50,001 to 300,000 square feet, greater than 300,000 square feet.

If property type=multi-family, then display the following selectable values: less than 30 units, 31 to 100 units, 101 to 300 units, 301 to 500 units, greater than 500 units.

If property type=office, then select the following selectable values: single-tenant, 2 to 10 tenants, 11 to 30 tenants, 31 to 60 tenants, greater than 60 tenants.

If property type=retail and subtype=neighborhood shopping center, then display the following selectable values: less than 20,000 square feet, 20,000 square feet or greater.

If property type=retail and subtype does not=neighborhood shopping center, then display the following selectable values: less than or equal to 100,000 square feet, greater than 100,000 square feet.

If property type=other, then display the following selectable values: single-tenant, 2 to 10 tenants, 11 to 30 tenants, 31 to 60 tenants, greater than 60 tenants. Values can be obtained from pull-down lists maintained by the Web site.

Number of Buildings on Site 726b is a user entered field for entering the number of distinct buildings on the site. Allowable values are any integer from 0 to 99.

FIG. 7c is an exemplary Select Environmental Firm Web Page 700c. The Select Environmental Firm Web Page 700c includes the following components: Descriptive Copy, Step Wizard 708c, Select checkbox, Vendor Name, Price Range 712a, back 702a, new quote 704c and continue 706c buttons. The Web site generates a table listing the vendors in alphabetical order by name. A user can click on a table head once to sort the list in ascending order on that header, and a second time to sort it in descending order. For example, if the user wants to sort the list by Price Range 712a, he or she can click once on the Price Range 712a table head to automatically sort the list from lows to highest price. Clicking on the header a second time will sort the list from highest to lowest price. Descriptive copy is a static-text description of the features and benefits of the current step in the process. This section is read-only and requires no user interaction. It can also indicate that only vendors selected will return results.

Step Wizard 708c provides a static-text description of the Select Environmental Firm page 700c and the steps required for a user to complete the page. This section is read-only and requires no user interaction.

The Select check box enables a user to select vendors from which she would like to receive a firm quote and contract. Headings on the vendor list can be services selected. Vendors can be sorted and listed by the services selected. Vendor name can provide a list of the environmental vendors that can provide services to the user based on the inputs the user and the vendors have provided. Vendor names can be hyperlinked. Clicking on the link opens environmental firm pop-up information page in another reduced sized browser instance. In one embodiment, no browser navigation features or URL address window will be available in the new browser instance. A vendor can supply all vendor can supply all vendor information to the Web site in a format that is specific to the Web site.

Price Range 712c provides the estimated price for a Phase I report or other environment service, based on the users input and cost information previously supplied by the vendors or by the vendors to the Web site. Back 702c, new quote 704c, and continue 706c buttons allow the user to navigate through the environmental services process, or to obtain a new quote for environmental services. Clicking the back button 702c returns the user to the Quote for Phase I page 700b if Phase I report was selected or to the Select Environmental Services page 700a if only non-Phase I reports were selected. All fields retain their previously input value so the user may make selected changes without reentering all the information on the page. Clicking the new quote button 704c returns the user to the Select Environmental Services page 700c. All fields are cleared so the user may request another soft quote. This button can clearly indicate that the user is quitting and starting over. Clicking the continue 706c or get quote button can move the user to the next step in the Environmental Service Process and open the Provide Contact Details page 700d.

FIG. 7d is an exemplary Provide Contact Details web page 700d. The Provide Contact Details web page 700d includes the following components: Descriptive Copy, Step Wizard 708d, Contact Details, Report Requirements, Back 702d, New Quote 704d, and Continue 706d buttons.

Descriptive Copy is a static text description of the features and benefits of the current step in the process. This section is a read-only section and requires no user interaction.

Step Wizard 708d provides the static text description of the provide contacts details page and the steps required for a user to complete the page. This section is a read-only section and requires no user interaction.

Contact Details contains several fields of information which can be populated with the registered user's default information. The default information can be overwritten if needed. Contact information must be entered into the Provide Contact Details Form to complete the request for a firm quote and to contract from the engineering vendors. Exemplary fields in the Provide Contact Details form can include: Name 710d, Street Address 712d, City 714d, State 716d, Zip Code 718d, Phone 720d, Fax 722d, E-mail 724d, and Report Requirements.

Name 710d is a user entered field for entering the name of the person who should receive the firm quote or contract from the environmental vendors. Allowable values are any alphanumeric or extended ASCII character.

Street Address 712d is a user entered field for entering the primary street address where the vendors should send the firm quote or contract. Allowable values are any alphanumeric or extended ASCII character.

City 714d is a user entered field for entering the city of the contact person.

State 716d is a user selected field for entering the contact person's state.

Zip Code 718d is a user entered field for entering the contact person's zip code.

Phone 720d is a user entered field for entering the contact person's area code and phone number, should the vendor have questions or need additional information.

Fax 722d is a user entered field for entering the contact person's fax number.

E-mail 724d is a user entered field for entering the contact person's e-mail address to receive electronic replies to her requests.

Report Requirements are two user entered fields for indicating when the user needs the draft and final property condition or other selected environmental report. The draft and final report requirements fields have visibly separate and identified areas for entering the month, date and year. The Web site includes the necessary logic to determine if the date entered is valid. If the date entered is not valid, the Web site returns an error message and require the user to reenter the data.

Back 702d, new quote 704d, and continue 706d buttons allow the user to navigate through the environmental services process or to obtain a new quote for environmental services. Clicking a back button 702d returns the user to the Select Environmental Firm page 700c if a Phase I report was selected, or to the Select Environmental Services page 700a a Phase I report was not selected. All fields retain the previously input values so the user can make selected changes without reentering all the information on the page. Clicking the new quote button 704c returns the user to the Select Environmental Services page 700a. All fields are cleared so the user may request another soft quote. Clicking the continue button 706c moves the user to the next step in the Environmental Service process and opens the Confirmation Page 700e of FIG. 7E.

The Confirmation Page 700e includes the following components: Descriptive Copy, Confirmation Message 702e, Hyperlinks 704e and 708e, and a Services Home button 706e. The Descriptive Copy is a static-text description of features and benefits of the current step in the process. This section is a read-only section and require no user interaction. Confirmation Message 702e indicates the property information and which vendors have been sent the Environmental Services Report Request, and hyperlinks 704e and 708e.

The Confirmation Page 700e also contains hyperlinks to other Web site sections 708e, thus providing suggestions to the user for other Web site features the user may find valuable.

Hyperlinks 708e link the user to the following sections: Order an Appraisal Report, Order an Asset Risk Assessment Accounting Report, Order an Engineering Report, Create A Research Package, Create A Valuation Package, Apply for A Loan, or Save this information to My Realworkspace. Clicking on a hyperlink can open the appropriate Web site page in the current browser window. Users can use the back button to return to the previous page. A Services Home button 706e sends the user to the Services Home page.

Appraisal Services

A third aspect of the due diligence process includes appraising the property in question. To assist a user in this aspect of the due diligence process, the Web site provides appraisal services. In step 304.19 a user selects Appraisal Services, and the Web site displays an Appraisal Services Landing page in step 304.20. In step 304.20 the Web site present the user with a list of appraisal services and reports that are offered through the Web site on the Appraisal Services Landing page. Appraisal Services section includes a multi-step process that in one embodiment enables a registered user to obtain a Property Valuation report from an appraiser. Through this process, a user first enters basic information about the property of interest. A user accesses the Appraisal Services section by clicking on the Appraisal Services navigation link on the Speed Up Due Diligence Landing page 400. The Web site requests firm quotes or estimates for obtaining a property valuation form from various vendors, based on specific information previously collected from those vendors. The user then selects one or more vendors and generates an e-mail to those firms to request a firm quote or contract. The appraisers then contact the user directly via e-mail, phone, fax and/or standard mail to provide those services.

In one embodiment, the Appraisal Services section includes the following pages: Select Appraisal Services 500a, Request Quote Form 500b, Select Appraisal Firm 500c, Provide Contact Details 500d, and Confirmation Page 500e. The Web site automatically saves and posts user-entered information into the Web site database when the page is completed and the continue button is clicked. The Web site tracks this information so that if the user is inadvertently booted from the Web site, she may recover the previously entered data and continue at the last saved point in the process without having to start over. Users proceed through the appraisal services section in a specific sequence because subsequent pages require information entered on previous pages.

In step 304.21, the Web site displays a Request Quote Wizard to assist a user through the process of obtaining a quote from a participating appraisal vendor. A Quote for Property Valuation Report page 500b is an exemplary first page for a Request Quote Wizard, and a user enters property information and requess the Web site to generate a cost estimate for appraisal services based on parameters provided by the appraisal vendors. The Quote for Property Valuation Report page 500b can only opened if a user has selected the Property Valuation Report as one of her choices in the Select Appraisal Services page 500a. If a user does not select a Property Valuation Report as one her choices, the Web site can skip this page and immediately open the Select Appraisal firm page 500c.

A user can select a non-property related service in step 304.22. Exemplary non-property related appraisal reports include: Ad Valorem Tax Appraisals, Feasibility Studies, Financial Reporting Valuations, Highest and Best Use, Impact Analysis, Insurance Placement, and Insurance Replacement Cost Studies. In these situations, users will not have to enter property-specific information and a soft quote will not be generated. Instead, the user can immediately proceed to the Select Appraisal Firm Screen 500c. The user can then select one or more vendors and generate an e-mail to those firms to request the specific information required. The appraisers will then contact the user directly via e-mail, phone, fax and/or standard mail to provide the information requested.

In step 304.23 the Web site evaluates the user's input and dynamically generates the Select Appraisal Firm Page 500c and table containing a list of vendors that match the user's criteria. Matching criteria to display the vendors can be as follows: for property-specific services parameters such as service provided, state, property type, subtype, site size, building size can be used. For non-property specific services: service provided and state parameters are used. The vendors can be grouped in the according to selected appraisal services, with each vendor listed under each applicable service. The heading for each group can include the name of the service. Output from filtering options can show approved vendors as “preferred” and the rest in a “other” list. When no matches can be found the Web site can display a message stating that no matches can be found.

Because access to specific services offered by the Web site are restricted to users who have purchased a various levels of subscriptions, the Web site must determine whether a user is registered or logged in. In decision step 304.24 the Web site can verify whether the user is registered with the Web site of logged on. Only registered users who are logged into the Web site can access the Provide Contact Details page 500d. In step 304.25 if the user who is unregistered or not logged in attempts to access this page, the Web site can ask the user to either register or log in. The Web site can provide the appropriate links or mechanism for the user to log in or register. In step 304.25, the Web site can generate a registration loop to register the user. The Provide Contact Details 500a page is a page that lists the user's contact information so that a selected service provider can contact the user directly. The Web site can display pre-populated contact details for registered or logged in users. The contact details can be overwritten by a user if necessary. The Web site can also display Report Requirements for a user to indicate when a draft and final version of a selected report is needed.

In step 304.26, the Web site displays the Contact Details Page 500a. Once the contact information is verified or entered, a user can select the continue or submit request button, and the Web site automatically submits the user's request with property information by e-mail to the selected vendor. If a vendor was listed for multiple services and selected multiple times on the Select Appraisal Firm page 500c then the request can be combined into one e-mail for that vendor, listing all services requested from that vendor. Each vendor can provide one main or two alternate e-mail addresses where the request should be sent. The Web site can automatically send the copies with no further user intervention. Vendors can be required by contract to respond to the user request by e-mail within one business day. The Web site automatically sends a copy of every quote requested and vendor response to a dedicated Web site e-mail address at the call center for tracking and managing the appraisal services process. This copy cannot include pricing information from the vendor but only indicates an e-mail response was sent.

In step 304.27 the Web site generates a Confirmation Page 500e which includes the following exemplary components: Descriptive Copy, Confirmation Message 502e, Hyperlinks 504e and 508e, and a Services Home button 506e. The Web site can also display other services available on the Web site. The Descriptive Copy is a static-text description of features and benefits of the current step in the process. This section ise a read-only section and require no user interaction. Confirmation Message 502e indicates the property information and which vendors have been sent the Appraisal Services Report Request, and hyperlinks 504e and 508e.

All pages in the Appraisal Services section include one or more logical navigation schemes such as a left navigation bar that will allow a user to link between pages and identify what steps he or she is on in the process at any time. Navigation between pages may be restricted based on defined business rules. For example, a user may not request a firm quote before the user has completed and saved the previous steps in the process.

Appraisal Service Web Pages

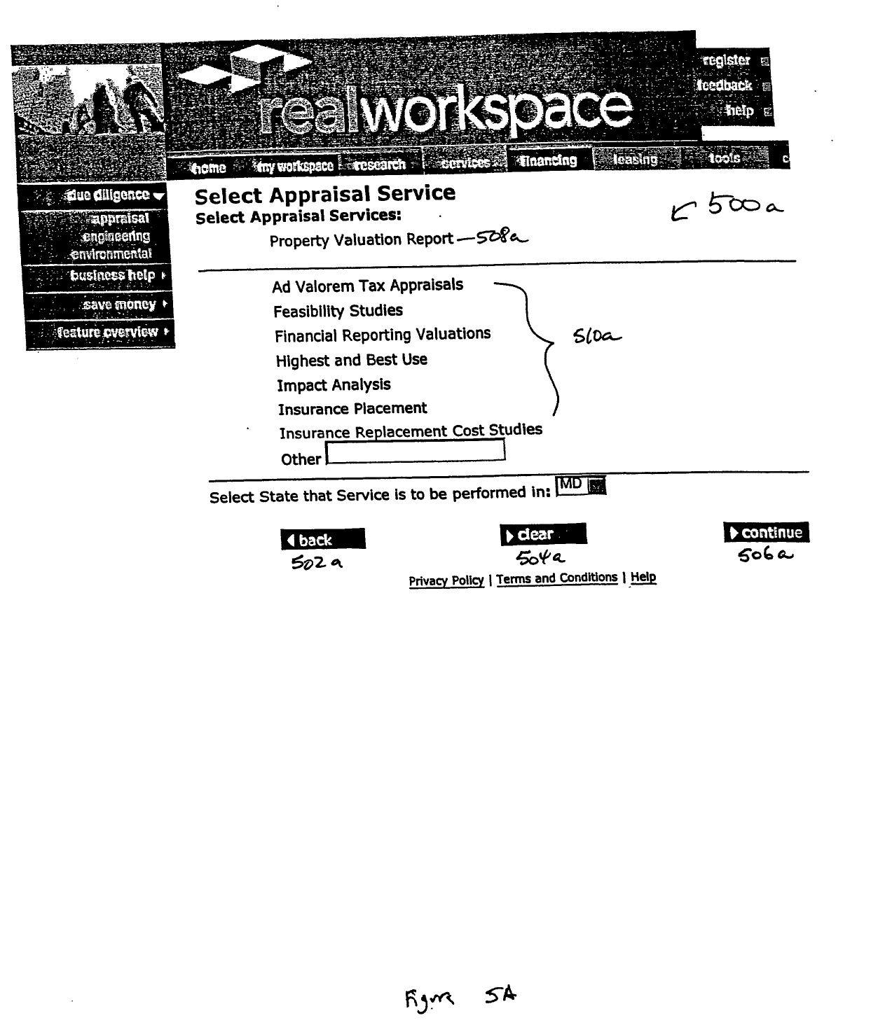

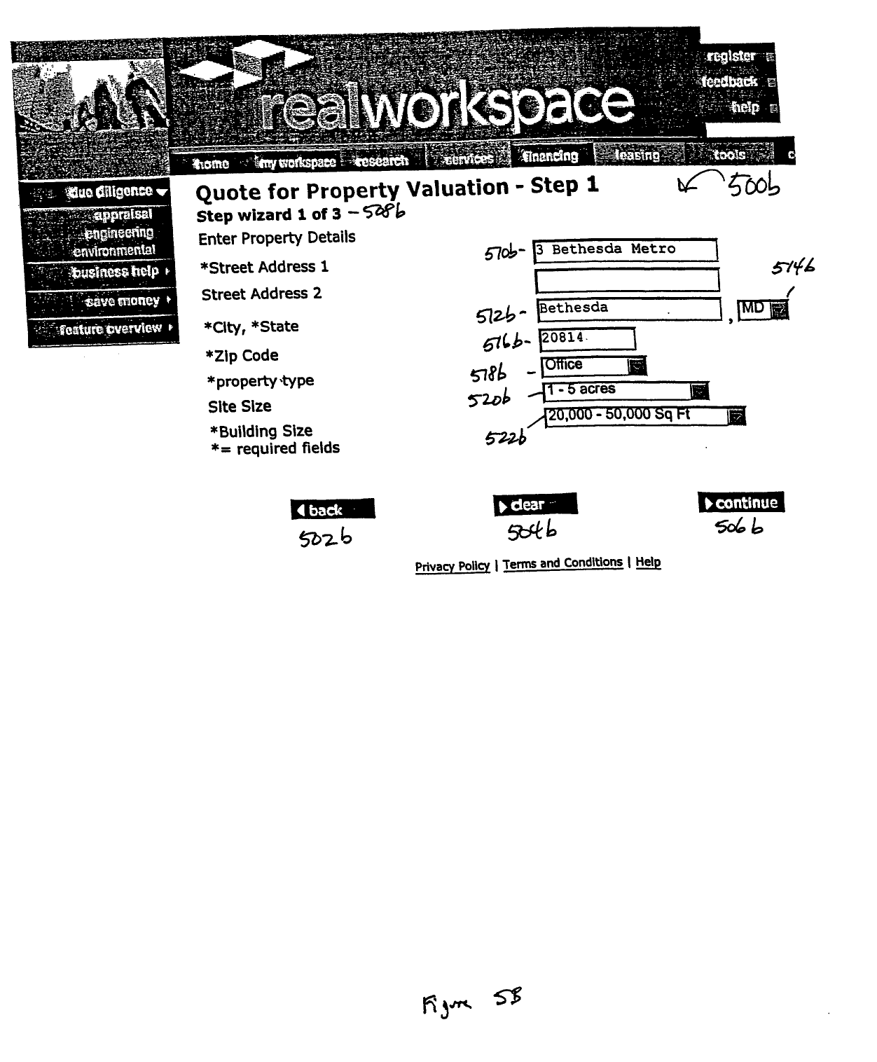

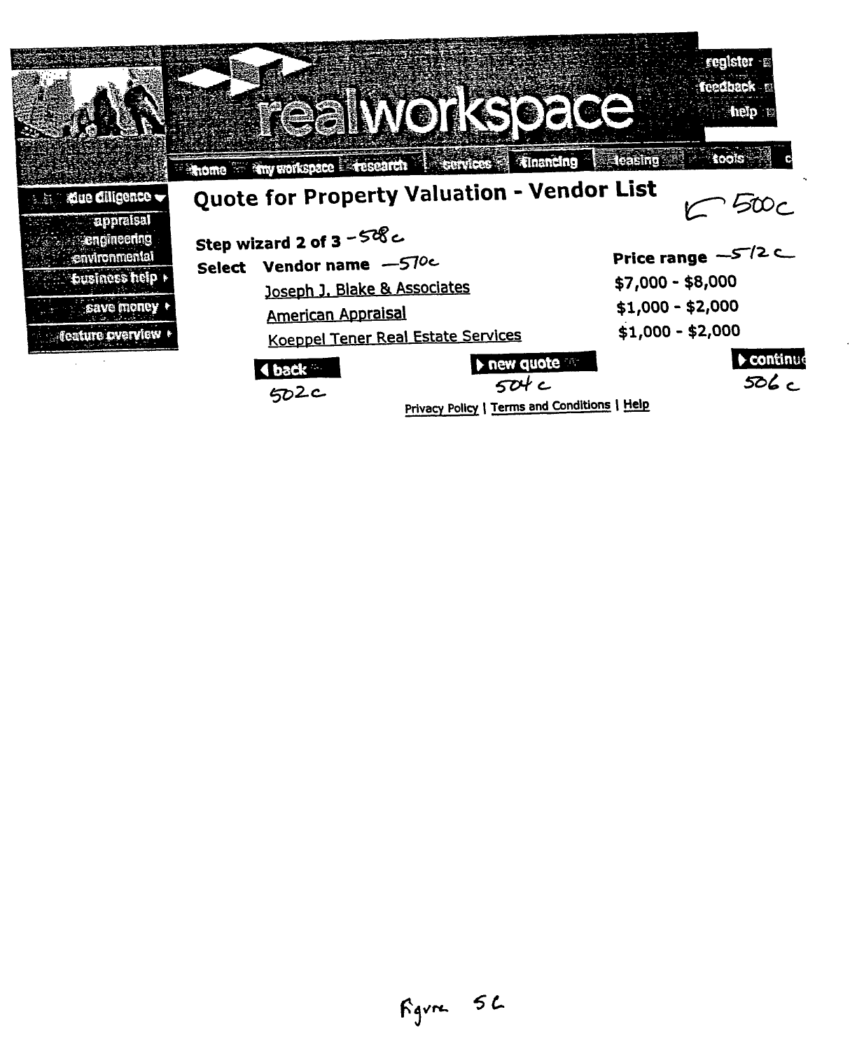

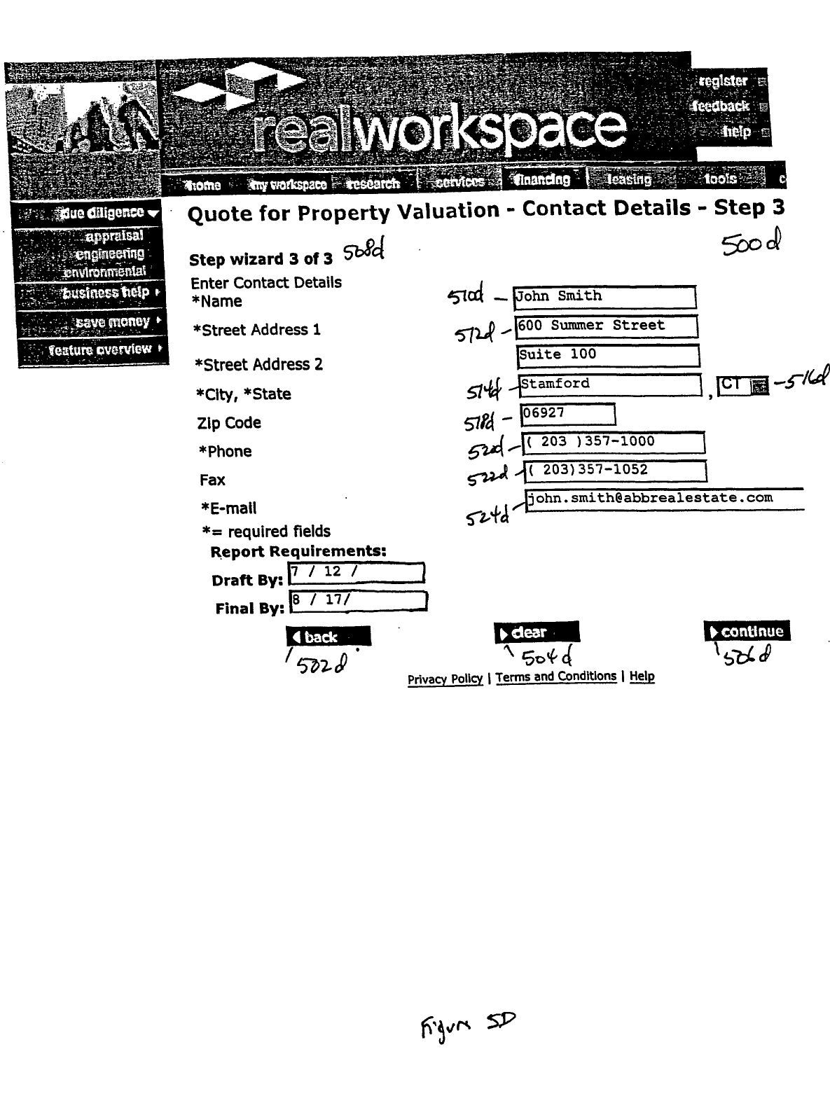

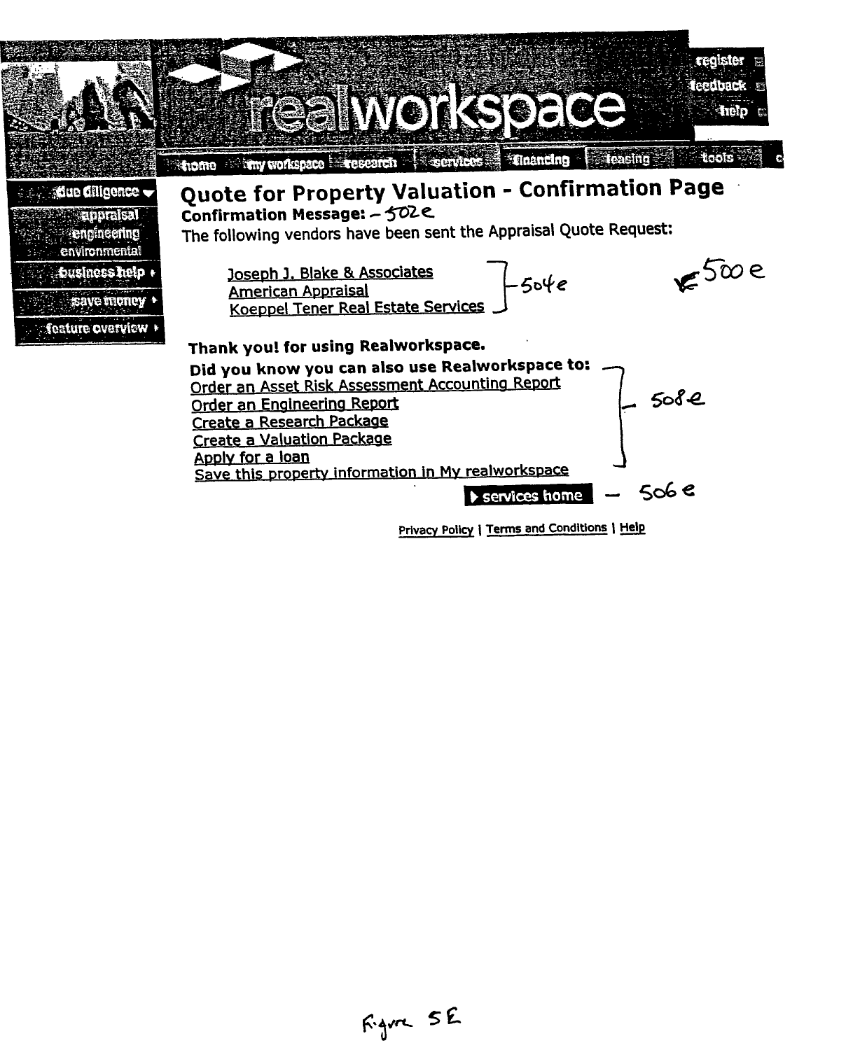

FIG. 5a is an exemplary Select Appraisal Services web page 500a. The Select Appraisal Services web page 500a includes the following components: Description of Appraisal Services, Hyperlinks to participating vendor information pages, Appraisal Services check box, and back 502a, clear 504a and continue 506a buttons. Description of Appraisal Services is a static text description of appraisal services and how they may be of value to the user. This section is read-only and requires no user interaction.

Hyperlinks to participating vendor information pages provide access to pop-up information about the participating appraisal firms. Logos or hyperlinked image maps link the user to an appraisal firm information page in a reduced sized browser instance or daughter window. In one embodiment, no browser navigation features or URL address window will be available. Participating vendors can provide all creative content such as logos and vendor information to the Web site in a Web site specified format. Users can close the daughter window and return to the active Select Appraisal Services page 500a by clicking on the close window button at the bottom of the window.

The Appraisal Services checkbox enables the user to select a Property Valuation Report or other appraisal services. A user selects Property Valuation Report 508a to obtain a quote from an appraisal firm for appraising the property. A user can also select from the following list of non-property related appraisal reports 510a to request vendors to send information about those reports: Ad Valorem Tax Appraisals, Feasibility Studies, Financial Reporting Valuations, Highest and Best Use, Impact Analysis, Insurance Placement, and Insurance Replacement Cost Studies. Users may select one or more porter services using a checkbox feature or other similar selection method. A user must select at least one report service before clicking the continue button at the bottom of the page to proceed. For non-property specific information, vendors can be matched by service and state.

The back 502a, clear 504a, and continue 506a buttons allow the user to navigate to different pages on the site. Clicking the back button 502a returns a user to the previous page she was on. Clicking the clear button 504a clears all the selections the user has made that remain on the Select Appraisal Services page 500a. Clicking the continue button 506a moves the user to the next step in the Appraisal Services process and opens the Request Quote Form 500b if Property Valuation Report is selected or Select Appraisal Firm page 500c if Property Valuation Report is not selected.

In step 304.31, the Web site displays a Quote for Property Valuation Report page 500b, and a user enters property information and requests the Web site to generate a cost estimate for appraisal services based on parameters provided by the appraisal services vendors. The Quote for Property Valuation page 500b can only be opened if a user has selected the Property Valuation Report 508a as one of her choices in the Select Appraisal Services page 500a. If a user does not select a Property Valuation Report 508a as one her choices, the Web site can skip this page and immediately open the Select Appraisal Firm page 500c.

FIG. 5b is an exemplary Quote for Property Valuation page 500b. The Quote for Property Valuation page 500b includes the following components: Description of Three-step Process, Step Wizard 508b, Property Details, Select Filtering Options, Back 502b, Clear 504b, and Continue 506b buttons. Description of the three-step process is a static test description of the three-step process a user can follow to obtain a Quote for Property Valuation Report. This section is read-only and requires no user interaction.

The Step Wizard 508b provides a static text description of the request firm quote page and the steps required for a user to complete this page. This section is a read-only section and requires no user interaction.

Property Details allows the user to enter property-specific information to obtain an accurate soft quote/estimate. If the state entered on the Select Appraisal Services page 500a is the same as the stored Current Property, then the Web site can populate the property details with the data from the stored Current Property. If the state entered on the Select Appraisal Services page 500a is not the same as stored in the current property, then the property details field should be empty, except that the state field can be populated with the state entered in the Select Appraisal Services page 500a. The Property Details has several data entry fields. Exemplary data entry fields can include: Street Address 510b, City 512b, State 514b, Zip Code 516b, Property Type 518b, Site Size 520b, and Building Size.

Street Address 51 Ob is a user entered field for entering the primary street address where the property is located. Allowable values are any alpha numeric or extended ASCII character.

City 512b is a user entered field for entering the city where the property is located.

State 514b is a user entered field for entering the state where the property is located. Values are obtained from a property type pull-down list maintained by the Web site.

Zip Code 516b is a user entered field for entering the property's zip code. Property Type 518b is a user selected field for entering the property/collateral type for the property in question. Values are obtained from a property type pull-down list maintained by the Web site. Exemplary property types include: industrial-single tenant, industrial-multi tenant, multi-family, office, retail, etc.

Site Size 520b allows a user to enter the lot size of the property. Values are obtained from a pull-down list maintained by the Web site. Exemplary table values can include: less than one acre, one to five acres, five to ten acres, greater than ten acres.

Building Size 522b allows a user to enter the building square footage floor space, the number of units, or the number of tenants depending on the property type selected. Once the user selects the property type above, the building size field can be generated based on the following business rules:

If property type=industrial, then display the following selectable values: less than or equal to 50,000 square feet, 50,001 to 300,000 square feet, greater than 300,000 square feet.

If property type=multi-family, then display the following selectable values: less than 30 units, 31 to 100 units, 101 to 300 units, 301 to 500 units, greater than 500 units.

If property type=office, then select the following selectable values: single-tenant, 2 to 10 tenants, 11 to 30 tenants, 31 to 60 tenants, greater than 60 tenants.

If property type=retail and subtype=neighborhood shopping center, then display the following selectable values: less than 20,000 square feet, 20,000 square feet or greater.

If property type=retail and subtype does not=neighborhood shopping center, then display the following selectable values: less than or equal to 100,000 square feet, greater than 100,000 square feet.

If property type=other, then display the following selectable values: single-tenant, 2 to 10 tenants, 11 to 30 tenants, 31 to 60 tenants, greater than 60 tenants.

Values can be obtained from pull-down lists maintained by the Web site.

FIG. 5c is an exemplary Select Appraisal Firm web page 500c. The Select Appraisal Firm web page 500c includes the following components: Descriptive Copy, Step Wizard 508c, Select checkbox, Vendor Name 510a, Price Range 512a, back 502a, new quote 504c and continue 506c buttons. The Web site generates a table listing the vendors in alphabetical order by name. A user clicks on a table head once to sort the list in ascending order on that header, and a second time to sort it in descending order. For example, if the user wants to sort the list by Price Range 512a, she can click once on the Price Range 512a table head to automatically sort the list from lows to highest price. Clicking on the header a second time will sort the list from highest to lowest price. Descriptive Copy is a static-text description of the features and benefits of the current step in the process. This section is read-only and requires no user interaction. It can also indicate that only vendors selected will return results.

Step Wizard 508c provides a static text description of the Select Appraisal Firm page 500c and the steps required for a user to complete the page. This section is read-only and requires no user interaction.

The Select check box enables the user to select vendors from which she would like to receive a firm quote and contract. Headings on the vendor list can be services selected. Vendors are sorted and listed by the services selected. Vendor name provides a list of the appraisal services vendors that can provide services to the user based on the inputs the user and the vendors have provided. Vendor names can be hyperlinked. Clicking on the link opens appraisal firm pop-up information page in another reduced sized browser instance. In one embodiment, no browser navigation features or URL address window will be available in the new browser instance. A vendor can supply all vendor can supply all vendor information to the Web site in a format that is specific to the Web site.

Price Range 512c provides the estimated price for a Property Valuation report or other appraisal service, based on the users input and cost information previously supplied by the vendors or by the vendors to the Web site. Back 502c, new quote 504c, and continue 506c buttons allow the user to navigate through the appraisal services process, or to obtain a new quote for appraisal services. Clicking the back button 502c returns the user to Quote for Property Valuation page 500b if Property Valuation report was selected or to the Select Appraisal Services page 500a if only Property Valuation report was not selected. All fields can retain their previously input value so the user may make selected changes without reentering all the information on the page. Clicking the new quote button 504c returns the user to the Select Appraisal Services page 500c. All fields can be cleared so the user may request another soft quote. This button can clearly indicate that the user is quitting and starting over. Clicking the continue 506c or get quote button moves the user to the next step in the Appraisal Services Process and open the Provide Contact Details page 500d.

FIG. 5d is an exemplary Provide Contact Details page 500d. The Provide Contact Details page 500d includes the following components: Descriptive Copy, Step Wizard 508d, Contact Details, Report Requirements 526d, Back 502d, Clear 504d, and Continue 506d buttons.

Descriptive Copy is a static text description of the features and benefits of the current step in the process. This section is a read-only section and requires no user interaction.

Step Wizard 508d provides the static text description of the provide contacts details page and the steps required for a user to complete the page. This section is a read-only section and requires no user interaction.

Contact Details contains several fields of information which can be populated with the registered user's default information. The default information can be overwritten if needed. Contact information must be entered into the Provide Contact Details Form 500d to complete the request for a firm quote and to contract from the appraisal services vendors. Exemplary fields in the Provide Contact Details form can include: Name 510d, Street Address 512d, City 514d, State 516d, Zip Code 518d, Phone 520d, Fax 522d, E-mail 524d, and Report Requirements 526d.

Name 510d is a user entered field for entering the name of the person who should receive the firm quote or contract from the appraisal services vendors. Allowable values are any alphanumeric or extended ASCII character.

Street Address 512d is a user entered field for entering the primary street address where the vendors should send the firm quote or contract. Allowable values are any alphanumeric or extended ASCII character.

City 514d is a user entered field for entering the city of the contact person.

State 516d is a user selected field for entering the contact person's state.

Zip Code 518d is a user entered field for entering the contact person's zip code.

Phone 520d is a user entered field for entering the contact person's area code and phone number, should the vendor have questions or need additional information.

Fax 522d is a user entered field for entering the contact person's fax number.

E-mail 524d is a user entered field for entering the contact person's e-mail address to receive electronic replies to her requests.

Report Requirements 526d are two user entered fields for indicating when the user needs the draft and final property condition or other selected appraisal report. The draft and final report requirements fields have visibly separate and identified areas for entering the month, date and year. The Web site includes the necessary logic to determine if the date entered is valid. If the date entered is not valid, the Web site returns an error message and require the user to reenter the data.

Back 502d, clear 504d, and continue 506d buttons allow the user to navigate through the appraisal services process or to obtain a new quote for appraisal services. Clicking a back button 502d returns the user to the Select Appraisal Firm page 500c if a Property Valuation Report was selected, or to the Select Appraisal Services page 500a if a Property Valuation Report was not selected. All fields can retain the previously input values so the user can make selected changes without reentering all the information on the page. Clicking the clear button 504d clears all fields. Clicking the continue button 506d moves the user to the next step in the Appraisal Service process and opens the Confirmation Page 500e of FIG. 5E.

The exemplary Confirmation Page 500e of FIG. 5e includes the following components: Descriptive Copy, Confirmation Message 502e, Hyperlinks 504e and 508e, and a Services Home button 506e. The Descriptive Copy is a static-text description of features and benefits of the current step in the process. This section is a read-only section and requires no user interaction. Confirmation Message 502e indicates the property information and which vendors have been sent the Appraisal Services Report Request, and hyperlinks 504e and 508e.

The Confirmation Page 500e also contains hyperlinks to other Web site sections 508e, thus providing suggestions to the user for other Web site features the user may find valuable. Hyperlinks 508e link the user to the following sections: Order an Asset Risk Assessment Accounting Report, Order an Engineering Report, Create A Research Package, Create A Valuation Package, Apply for A Loan, or Save this information to My Realworkspace. Clicking on a hyperlink opens the appropriate Web site page in the current browser window. Users can use the back button to return to the previous page. A Services Home button 506e can send the user to the Services Home page.

Help You Save Money

In addition to Due Diligence services, the Web site offers other services such services designed to assist the user in saving money. The user can save money on purchases of services and products by leveraging off of the Web site large volume buying discounts. FIG. 3C demonstrates the process 306 wherein a user selects Help You Save Money. The Help You Save Money process 306 allows registered users to access and search for discounted products and services available. The Web site displays a page containing hyperlinks to other sites on the Web site, and the page can also display information about particular services. Users can use the site to find out the different information about particular products and services to and including the purchase of a product or service. Users can save money by comparing prices from different service providers and vendors, and selecting the most inexpensive services or products. Exemplary services offered on Help You Save Money landing page include but not limited to: Appliances, Carpets/Flooring, Electrical Products, Elevator Services, HVAC Web sites, Lighting Web sites, Risk Management, Roofing Web sites, Title Insurance, Water Conservation, and Waterproofing. In step 360, the Web site can provide links to a vendor page describing appliance products the vendor can offer.

In step 362, the Web site provides links to a vendor page describing carpet and flooring products the vendor can offer. In step 364, the Web site provides links to a vendor page describing electrical products the vendor can offer. In step 366, the Web site provides links to a vendor page describing elevator services the vendor can offer. In step 368, the Web site provides links to a vendor page describing HVAC products the vendor can offer. In step 370, the Web site provides links to a vendor page describing lighting Web sites the vendor can offer. In step 372, the Web site provides links to a vendor page describing risk management products or services the vendor can offer. In step 374, the Web site provides links to a vendor page describing roofing Web sites the vendor can offer. In step 376, the Web site provides links to a vendor page describing title insurance services and products the vendor can offer. In step 378, the Web site provides links to a vendor page describing water conservation products the vendor can offer. In step 380, the Web site provides links to a vendor page describing waterproofing products the vendor can offer. The users can always elect a service or return to the previous location using the browser's back button.

Run Your Business More Efficiently

Alternatively, the user can select Run Your Business More Efficiently and proceed through process 308 of FIG. 3d. The Run Your Business More Efficiently process 308 allows registered users to obtain a variety of discounted products and services. The Web site displays a Run Your Business More Efficiently landing page. The landing page contain links to the following exemplary services: Hire Employees, Find Short Term Cash, Buy/Lease Equipment, Payroll Processing, Company Credit Cards, Employee Benefits, and Accounting Services. Hire employees in step 382 allows users to post jobs or search for candidates directly from the vendor's real estate professionals recruiting Web site. Thus, clicking on the Hire Employees hyperlink opens a co-branded site to the current browser window. A co-branded site is a site that includes information identifying the Web site as well as information identifying a service provider. For example logos relating to the Web site and to a vendor can be displayed simultaneously on a display page. Users can then employ the posting and candidate search functionality as defined by the particular vendor. In one embodiment, the co-branded site uses vendor supplied content framed within the particular navigation scheme.

In step 384, registered users access other Web sites via hyperlinks to obtain discounted products and services. The Web site displays a Find Short Term Cash hyperlinks that open a co-branded site and display information about that particular service. The users can then use the inherent functionality of the co-branded site to find out additional information about a particular product or service up to and including the purchase of that product or service. As in the previous example, the co-branded site can display vendor supplied content framed within a particular navigation scheme.

When the user selects Buy/Lease Equipment in step 386, the Web site allows registered users to click on any of the displayed hyperlinks that can open the co-branded site and display information about buying or leasing equipment. Users can then use the inherent functionality of the co-branded site to find out additional information about a buying or leasing equipment up to and including the purchase of equipment or service. The co-branded site can use vendor supplied content framed within a specific navigation scheme.

When the user selects Payroll Processing in step 388, the Web site allows registered users to access and search a site for information on Payroll Processing Services available to users. The Web site displays hyperlinks that open a co-branded site and displays information about payroll processing services. Users can then use the inherent functionality of the co-branded site to find out additional information about payroll processing services up to and including the purchase of that service. The co-branded can use vendor supplied content framed within a specified navigation scheme.

When the user selects Company Credit Cards in step 390, the Web site allows registered users to access the site to apply for on-line company credit cares. The Web site displays hyperlinks that open a co-branded site and display information and or a form wizard about credit card services. Users can then use the inherent functionality of the co-branded site to find out additional information about credit card services, up to and including applying for a credit card on line. The co-branded site can use supplied content framed in a specified navigation scheme.

Selecting the Employees Benefits in step 392 allows the user to access and search the site for information on employee benefits. The Web site displays hyperlinks that can open a co-branded site and display information about that employee benefits. Users can then use the inherent functionality of the co-branded site to find out additional information about a particular employee benefits service up to and including the purchase of that service. The co-branded site displays vendor supplied content framed within a specified navigation scheme.

When the Accounting Services is selected in step 394, the Web site enables a registered user to request an Asset Risk Assessment from an accounting firm. The user selects a particular accounting service in step 394.1. The user then enters basic information about the property and his or her company in step 394.3, or information about a company only in 394.2. Next, the Web site generates time estimates for obtaining the Asset Risk Assessment for various vendors, based on specific information previously collected from those vendors. In step 394.4 the Web site displays the list of vendors, and a user then selects one or more vendors and generates an E-mail to those firms to request a firm quote and contact. The accounting firms can then contact the user directly by E-mail, phone, fax and/or standard mail to provide those services.

Users can also request other non-property specific information from accounting firms. In these situations, the users will not have to enter property specific information in fields for generating property data will not be generated. The Web site generates time estimates for obtaining the services from various vendors, based on specific information previously collected from those vendors. The user then select one or more vendors and generate an E-mail to those firms to request the information. A user can supply contact information so that accounting firms can then contact the user directly via mail, phone, fax and/or standard mail to provide the information.

In step 394.7 the Web site displays a Provide Contacts Details Form. Only registered users who are logged into the Web site can access the Provide Contact Details Page. In decision step 394.5, if the user who is unregistered or not logged in attempts to access this page, the Web site can ask the user to either register or log in. The Web site can provide the appropriate links or mechanism for the user to log in or register. In step 394.6, the Web site can generate a registration loop to register the user.

The Provide Contact Details Form contains several fields of information which can be populated with the registered user's default information. The default information can be overwritten if needed. Contact information must be entered into the Provide Contact Details Form to complete the request for a firm quote and to contract from the appraisal services vendors. Exemplary fields in the Provide Contact Details form can include: Name, Street Address, City, State, Zip Code, Phone, Fax, E-mail, and Report Requirements . These fields can contain data as previously described.

In step 394.7 the Web site displays a Provide Contact Details page so the user can enter contact information. The Provide Contact Details page includes the following components: Descriptive Copy, Step Wizard, Contact Details, Report Requirements, Back, Clear, and Continue buttons as previously described.

In step 394.8 the Web site displays a Confirmation Page. The Web site then generates a Confirmation Page which includes the following components: Descriptive Copy, Confirmation Message, Hyperlinks, and a Services Home button. The Descriptive Copy is a static-text description of features and benefits of the current step in the process. This section is a read-only section and requires no user interaction. The Confirmation Message indicates the information and which vendors have been sent the Appraisal Services Report Request, and hyperlinks. The hyperlinks to other Web site sections provide suggestions to the user for other Web site features the user may find valuable. Clicking on a hyperlink opens the appropriate Web site page in the current browser window. Users can use the back button to return to the previous page. A Services Home button 506e can send the user to the Services Home page.

Quick Feature Overview

FIG. 3e describes the Quick Feature Overview process 310. The Quick Feature Overview process 310 can describe the functionality of the services section and its modules to the user in an easy to understand and intuitive format. In step 310.1 users can access the Quick Feature Overview by clicking on the appropriate button or tab on the Web site site.

The invention provides a novel method of improving the efficiency and effectiveness of commercial real estate transactions by providing a Web site that can serve as a commercial real estate professional's workspace to obtain industry specific content, use support tools, benchmark performance, and access vendors in a personalized environment. The Web site can facilitate the offering of multiple services relating to the property management. These services can include site appraisal, engineering, and environmental services in an on-line computing environment such as the global Internet.

The remote server of invention can also support a portal operation by providing a central Web site for consumer's real estate related operations. The portal operated by this server platform can enable the user to create a “personalizable” workspace for her real estate-related transactions. In view of the foregoing, it will be understood that the remote server can support both an ASP model and a portal Web site for servicing the needs of real estate consumers.

Although the invention has been described in the context of commercial real estate property, it will be apparent to one of ordinary skill in the art that the invention is also applicable to residential real estate and related services and products.

What is claimed is:

1. A process for obtaining a service in support of commercial real estate transactions, comprising:
providing a virtual marketplace for commercial real estate service providers using a distributed computer network, wherein users requiring commercial real estate services can access the marketplace and can electronically request information on commercial real estate services from a service provider; and
responding to requests for information on commercial real estate services by electronically providing requested information at the virtual marketplace wherein the requested information is published as one of textual information or links to commercial real estate service provider web sites.

2. The process of claim 1, further comprising the step of:
responding to requests for quotes on commercial real estate services or products by providing cost estimates for specified services or products based on criteria provided by participating service providers.

3. The process of claim 2, further comprising the step of:
matching users in need of commercial real estate services or products with vendors of the needed commercial real estate services or products based on criteria provided by users and service providers.

4. The process of claim 3, further comprising the step of:
concluding the transaction by providing a means for a user in need of commercial real estate services or products to electronically purchase the services or products.

5. An on-line process for completing a transaction for a commercial real estate service via a distributed computing environment comprising:
responding to electronic requests from users seeking commercial real estate services by supplying information on user specified commercial real estate services and commercial real estate service providers and providing users with links to commercial real estate service provider information web pages;
responding to electronic requests for a quote on commercial real estate services by providing a cost estimate of services based on previously supplied commercial real estate service provider information; and
providing a means for a user seeking commercial real estate services to purchase selected commercial real estate services.

6. A process for providing due diligence services for commercial real estate transactions using a distributed computer network, comprising:
providing users with links at a Web site to providers of engineering, environmental, and appraisal services;
responding to requests for quotes on due diligence services by supplying at the Web site a price estimate for specified services by comparing the service requested by a user with a service provider's price for the requested service and displaying the service provider's price for the requested service;
matching a user in need of due diligence services with a provider of due diligence services by displaying providers of the requested due diligence services to the user; and
providing a means for a user in need of due diligence services to purchase specified due diligence services in an on-line environment.

7. The process of claim 3, wherein the due diligence service comprises an engineering service, environmental service, or an appraisal service.

8. The process of claim 4, wherein the engineering service comprises a property condition report.

9. The process of claim 4, wherein the environmental service comprises a Phase I, Phase II, or Phase III environmental assessment.

10. The process of claim 4, wherein the appraisal service comprises a property valuation report.
